(19) United States
(12) Patent Application Publication
(10) Pub. No.: US 2026/0335822 A1
(43) Pub. Date: Oct. 29, 2026

(54) PHOTOELECTROCHEMICAL CAPTURE OF ACID GASES

(71) Applicant: Massachusetts Institute of Technology, Cambridge, MA (US)

(72) Inventors: Trevor Alan Hatton, Sudbury, MA (US); Alexandra Victoria Tavasoli, Cambridge, MA (US); Vittoria Bolongaro, Zurich (CH); Kyle M. Diederichsen, Cambridge, MA (US)

(73) Assignee: Massachusetts Institute of Technology, Cambridge, MA (US)

(21) Appl. No.: 19/107,138

(22) PCT Filed: Aug. 29, 2023
(86) PCT No.: PCT/US2023/031357

§ 371 Date: Feb. 27, 2025

Related U.S. Application Data
(60) Provisional application No. 63/373,897, filed on Aug. 30, 2022.

(51) Int. Cl. B01D 53/32; B01D 53/14

(52) U.S. Cl. CPC B01D 53/326; B01D 53/1456; B01D 2252/205

(57) ABSTRACT

Systems and methods for redox-driven gas separation, such as via photoelectrochemical capture of acid gases, are generally described. What is described herein is a method, apparatus, and system for the photoelectrochemical capture of acid gases from a fluid gas mixture, as well as the photoelectrochemical release of the captured acid gas into a concentrated stream of the acid gas. Acid gases of industrial relevance can include carbon dioxide (CO₂), various sulphur or nitrogen oxides (SOₓ, NOₓ), or hydrogen sulfide (H₂S). Certain embodiments are related to photoelectrochemical systems comprising a photoelectrode which, upon illumination with light, induces oxidation or reduction of redox-active species in an electrolyte solution in the system, that, when brought into contact with a fluid gas mixture including an acid gas, capture acid gases from the fluid gas mixture by raising the pH of the electrolyte solution or chemically binding to the acid gas molecule. The methods, apparatuses, and systems described herein are useful in carbon capture and pollution mitigation applications, and in direct use of solar energy to drive the capture and release of acid gases from fluid gas mixtures.

### RELATED APPLICATIONS

This application claims priority under 35 U.S.C. § 119(e) to U.S. Provisional Patent Application No. 63/373,897, filed Aug. 30, 2022, and entitled “Photoelectrochemical Capture of Acid Gases (Solar-Driven Carbon Dioxide Capture),” which is incorporated herein by reference in its entirety for all purposes.

### TECHNICAL FIELD

Systems and methods for redox-driven gas separation, such as via photoelectrochemical capture of acid gases, is generally described.

### BACKGROUND

The capture of gases from fluid gas mixtures is an important industrial separation process that is used in the purification of gaseous products for industrial purposes, either for the purpose of using the purified gas in a downstream process, selling it as a purified product, or for the removal of environmental pollutants or undesirable components from the mixed gas stream. The capture of acid gases specifically from industrial waste streams, or directly from the ambient atmosphere, for the purpose of reducing pollution levels that adversely affect society has been an industrial practice for decades and remains a process that requires high amounts of energy. These acid gases can include carbon dioxide (CO₂), various sulphur or nitrogen oxides (SOₓ, NOₓ), or hydrogen sulphide (H₂S). At present, a high degree of technical and commercial interest lies in the capture of CO₂ from waste gas streams or directly from the ambient air that makes up the atmosphere, the goal of which is to mitigate the changes to the global climate that result from the accumulation of CO₂ in the atmosphere.

The energy required to drive these gas separation processes can be provided through the application of pressure, thermal or electrical energy, humidity, or incident radiation. The full “separation process” includes the capture of an acid gas from the fluid gas mixture, the release of a purified stream of the fluid gas mixture with a depleted concentration of the acid gas, and the subsequent release of the acid gas from the sorbent, solvent, or membrane into a concentrated stream of the captured gas, which can then be stored permanently to remove the gas from the planetary system, or utilized in a downstream industrial or chemical process to manufacture a commercial or industrial product for economic gain. In the example case of CO₂, these downstream processes can include pressurization and injection into geological formations for permanent storage and removal from the atmosphere, conversion via chemical transformation into chemicals or fuels, or use in industrial metallurgical or food processing.

### SUMMARY

Systems and methods for redox-driven gas separation, such as via photoelectrochemical capture of acid gases, are generally described. The subject matter of the present invention involves, in some cases, interrelated products, alternative solutions to a particular problem, and/or a plurality of different uses of one or more systems and/or articles.

In one aspect, systems for gas separation are provided. In some embodiments, the system comprises an electrochemical cell comprising: a first chamber comprising: a first electrode, an inlet configured to receive a fluid mixture comprising a deactivated electroactive sorbent, and an outlet configured to output a fluid mixture comprising an activated electroactive sorbent generated in at least in part via an electron transfer reaction involving the first electrode; and a second chamber comprising a second electrode in electrical communication with the first electrode, wherein the first electrode and/or the second electrode is a photoelectrode; and a contactor configured to expose activated electroactive sorbent to a fluid mixture comprising an acid gas, wherein the activated electroactive sorbent has: (a) a higher binding constant for bonding to the acid gas or a portion thereof than does the deactivated electroactive sorbent; and/or (b) a higher pKₐ in water at 298 κ than does the deactivated electroactive sorbent; wherein the contactor comprises: a sorbent inlet fluidically connected to the outlet of the first chamber, and an acid gas inlet configured to receive the fluid mixture comprising the acid gas.

In another aspect, methods for gas separation are provided. In some embodiments, the method comprises exposing a first electrode and/or a second electrode of an electrochemical cell to electromagnetic radiation such that an electron transfer reaction occurs resulting in a deactivated electroactive sorbent being converted to an activated electroactive sorbent within the electrochemical cell; removing at least some of the activated electroactive sorbent from the electrochemical cell; and exposing at least some of the removed activated electroactive sorbent to a fluid mixture comprising an acid gas such that the at least some of the removed activated electroactive sorbent induces capture of the acid gas from the fluid mixture.

In some embodiments, the method comprises exposing a deactivated electroactive sorbent and/or a component in redox communication with the deactivated electroactive sorbent to electromagnetic radiation such that an electron transfer reaction occurs resulting in the deactivated electroactive sorbent being converted to an activated electroactive sorbent within the electrochemical cell; and exposing at least some of the activated electroactive sorbent to an acid gas such that the at least some of the activated electroactive sorbent covalently bonds to the acid gas or a portion thereof.

One aspect of the disclosure herein is a photoelectrochemical apparatus comprising: p1 a. an anode flow chamber that contacts an anolyte with an electrode, wherein illumination oxidizes the anolyte at the interface of a photoanode;
b. a cathode flow chamber which contacts a catholyte with an electrode, which, upon illumination reduces the catholyte;
c. an ion exchange membrane configured to facilitate diffusion of ions between the anode flow chamber and the cathode flow chamber and maintain charge neutrality.

In some embodiments, the catholyte is reduced at the interface of a photocathode. In some embodiments, the anolyte or catholyte formed at the interface with the photoanode or photocathode, respectively, causes capture of acid gases. In some embodiments, the anolyte or catholyte formed at the interface with the photoanode or photocathode, respectively, causes production of acid gases.

One aspect of the disclosure herein is a method for capturing acid gases using the photoelectrochemical apparatus.

One aspect of the disclosure herein is a system for capturing acid gases comprising the photoelectrochemical apparatus and auxiliary process components comprising a tank for capturing acid gases.

Other advantages and novel features of the present invention will become apparent from the following detailed description of various non-limiting embodiments of the invention when considered in conjunction with the accompanying figures. In cases where the present specification and a document incorporated by reference include conflicting and/or inconsistent disclosure, the present specification shall control.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIG. 1A is a schematic diagram of a system for gas separation comprising an electrochemical cell having a first electrode and a second electrode, where at least the first electrode is a photoelectrode, according to some embodiments;

FIG. 1B is a schematic diagram of a system for gas separation comprising an electrochemical cell having a first electrode and a second electrode, where at least the second electrode is a photoelectrode, according to some embodiments;

FIG. 2A is a schematic diagram of a system for gas separation comprising a first electrochemical cell having a first electrode and a second electrode and a second electrochemical cell having a first electrode and a second electrode, where at least the first electrode of the second electrochemical cell is a photoelectrode, according to some embodiments;

FIG. 2B is a schematic diagram of a system for gas separation comprising a first electrochemical cell having a first electrode and a second electrode and a second electrochemical cell having a first electrode and a second electrode, where at least the second electrode of the second electrochemical cell is a photoelectrode, according to some embodiments;

FIG. 2C is a schematic diagram of a system for gas separation comprising a first electrochemical cell having a first electrode and a second electrode and a second electrochemical cell having a first electrode and a second electrode, where at least the second electrode of the first electrochemical cell and the second electrode of the second electrochemical cell are photoelectrodes, according to some embodiments;

FIG. 3 is a flow diagram of an example method for capturing acid gases using a light-mediated apparatus, according to some embodiments;

FIG. 4 is an exploded perspective view illustration of functional components comprising an example of the photoelectrochemical apparatus that facilitates the activation of the ability of the system to capture acid gases upon illumination with light, according to some embodiments;

FIGS. 5A-5E are exploded perspective view illustrations of photoelectrochemical flow cell components, according to some embodiments;

FIG. 6 is a drawing of a photoelectrochemical apparatus, according to some embodiments;

FIG. 7 is a schematic diagram of a present example of materials and redox-active components used in a demonstration cell, according to some embodiments;

FIG. 8 is a schematic of an example of a light-driven CO₂ capture system, according to some embodiments;

FIG. 9 is a drawing of the system depicted in FIG. 7,

FIGS. 10A-10B show plots of preliminary data showing CO₂ capture and corresponding unbiased photocurrent, according to some embodiments;

FIGS. 11A-11D show plots of data of CO₂ reading (%) (FIG. 11A), pH (FIG. 11B), cell voltage (FIG. 11C), and cumulative CO₂ captured versus time for a system, according to some embodiments; and

FIG. 12 shows a detail of the data from FIG. 11C shown versus cumulated capacity, according to some embodiments.

### DETAILED DESCRIPTION

Systems and methods for redox-driven gas separation, such as via photoelectrochemical capture of acid gases, are generally described. In some embodiments, electromagnetic radiation exposure (e.g., of one or more electrodes of an electrochemical cell) contributes to the activation of an electroactive sorbent. The activated electroactive sorbent may cause an acid gas to be captured (e.g., via bonding to the sorbent and/or via one or more proton transfer reactions). In some instances, activated electroactive sorbent is removed from the electrochemical cell in which it is generated prior to exposure of the activated electroactive sorbent to the acid gas (e.g., in a contactor).

One example of an embodiment of this disclosure is a photoelectrochemically-driven flow system for the capture of acid gases from a gas mixture. In an exemplary embodiment of this system, an anolyte containing a counter-electrolyte (e.g., a redox-active molecule) is flowed through an anode chamber of a photoelectrochemical flow cell, where the counter-electrolyte comes into contact with a photoanode. Upon illumination, the photoanode may facilitate the oxidation of the counter-electrolyte in the anolyte, producing an electric current. The current is then carried to the cathode chamber of the photoelectrochemical flow cell, where the reduction of the deactivated electroactive sorbent (e.g., an optionally-substituted quinone) in the catholyte liquid occurs, thereby forming an activated electroactive sorbent. The activated electroactive sorbent in the catholyte may then be flowed into a contactor where it is contacted with a fluid mixture (e.g., a gas mixture) comprising an acid gas molecule to be captured, and causes the capture of the acid gas molecule by chemical and/or physical interaction. In this embodiment, the catholyte acts as the sorbent. The acid gas-containing (e.g., acid gas-saturated) catholyte sorbent can be regenerated through the opposite process by which it was activated, by flowing it through another photoelectrochemical cell in which it may be oxidized in the anolyte chamber by a photoanode, thereby releasing the acid gas and regenerating the sorbent. As described in more detail below, other configurations are also possible.

It has been realized in the context of this disclosure that it can be desirable to use incident radiation to drive the separation of an acid gas from a fluid gas mixture. The usefulness of such a process may lie in the direct use of light, for example solar energy to drive the capture and release of acid gases from fluid gas mixtures, bypassing the need to generate electricity or thermal energy in the separation process, and therefore saving a portion of the considerable electrical or thermal energy required for these processes. One specific interest is the use of one or more embodiments of this invention to capture of CO₂ from industrial waste streams, or directly from the ambient atmosphere, as a method of reducing the atmospheric concentration of CO₂ that is the principal cause of climate change.

With regards to this latter application, several of the Intergovernmental Panel on Climate Change's (IPCC) recommended global warming mitigation pathways include the use of CO₂ capture technologies to reduce atmospheric concentrations of CO₂. The IPCC recommends the removal of 10 gigatonnes of CO₂ per year to stave off the worst effects of climate change. At this scale, capturing CO₂ directly from the air is projected to require up to 100 exajoules of energy, equivalent to current total global electricity production and one sixth of total energy supply. As such, the ability to reduce the required infrastructure for CO₂ capture using the technology described herein which relies solely on illumination by solar energy, would be of significant commercial interest.

The capture of acid gases from fluid mixtures has been demonstrated using liquid or solid sorbents, liquid solvents, or membrane technologies. These technologies require the application of heat, electricity, or humidity to capture, release, or both capture and release the acid gas from an inlet gas mixture.

In contrast, the light-mediated capture of acid gases using photoelectrochemical methods described herein can operate using only illumination from a light source, for example natural sunlight. As such, significant energy savings can be accomplished by eliminating the need for electrical or thermal energy delivery to the capture device, as is required in existing methods.

Application of electrical or thermal energy may still need to be applied to drive components auxiliary to the capture and release photoelectrochemical cells, such as pumps, actuators, and other control systems or unit operations surrounding the photoelectrochemical cells in an industrialized process.

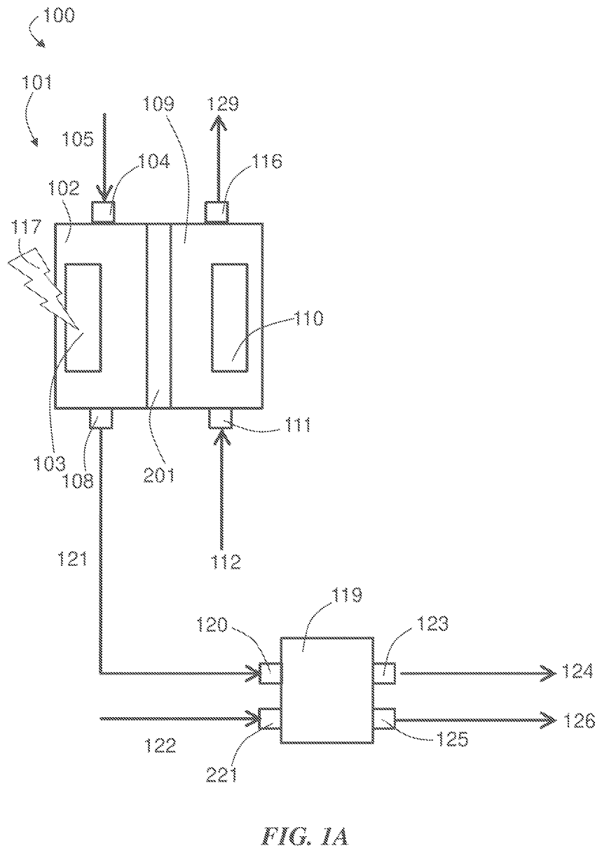

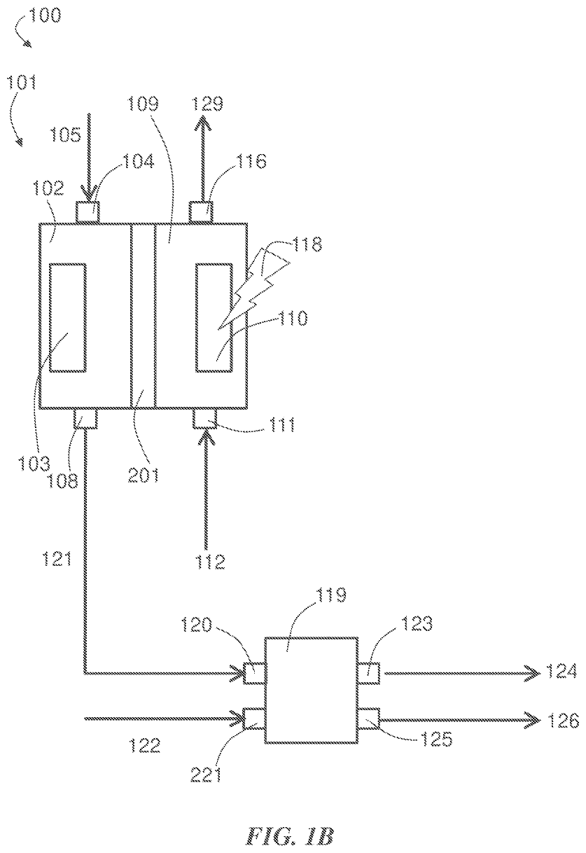

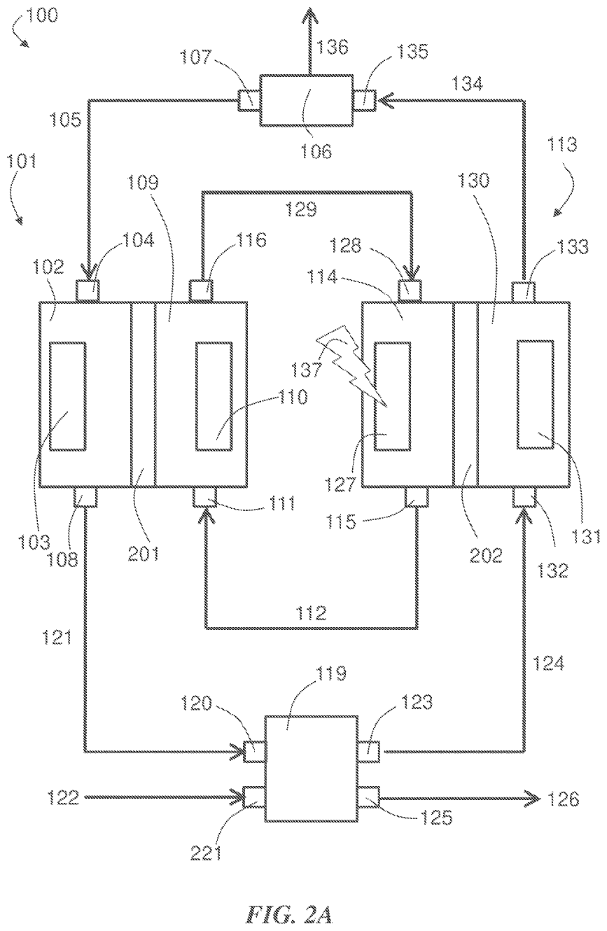

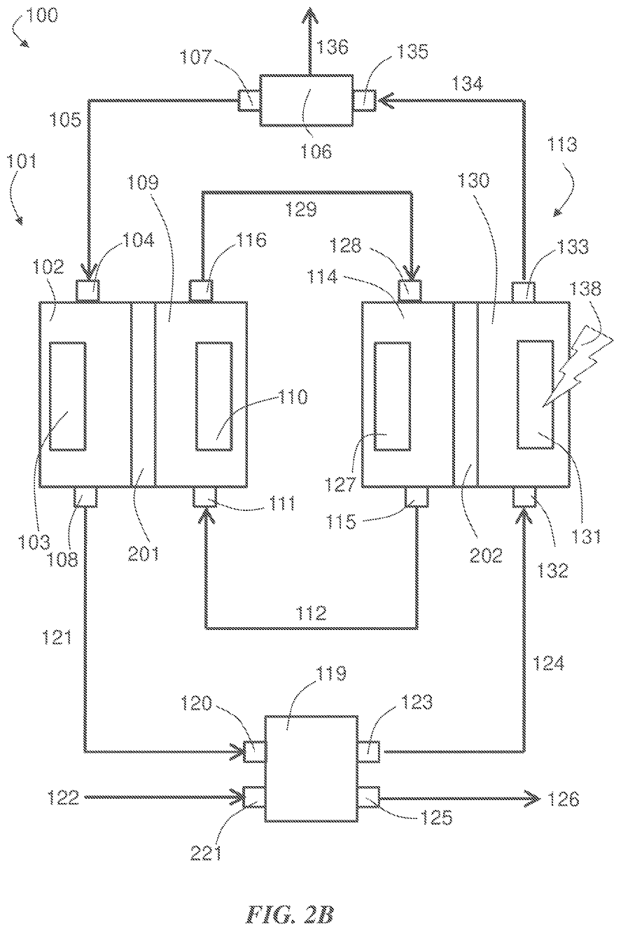

In one aspect, systems for gas separation (e.g., gas capture) are described. FIGS. 1A-2C show schematic diagrams of various examples of embodiments of system 100. The system may be configured to receive electromagnetic radiation (e.g., ultraviolet and/or visible light) and drive one or more electron transfer reactions resulting in the conversion of a deactivated electroactive sorbent to an activated electroactive sorbent that subsequently causes an acid gas (e.g., carbon dioxide) to be separated from a fluid mixture (e.g., an input gas stream) via a capture process. Further details of the system and related methods are described below.

In some embodiments, the system comprises one or more electrochemical cells. For example, as shown in FIGS. 1A-2C, system 100 comprises first electrochemical cell 101. The electrochemical cell may be an electrolytic cell in which an energy input (e.g., from incident electromagnetic radiation and/or an electrical power source) provides the driving force for one or more chemical reactions involving an oxidation process at one electrode and a reduction process at another electrode. In some embodiments, the electrochemical cell is a flow cell in which one or more of the chemical reactions involves a component at least partially dissolved and/or suspended in a liquid that is flowed into and out of a chamber of the electrochemical cell.

In some embodiments, the electrochemical cell comprises a first chamber comprising a first electrode. For example, referring back to FIGS. 1A-2C, first electrochemical cell 101 may comprise first chamber 102 comprising first electrode 103. First chamber 102 may be a vessel having an interior volume capable of being at least partially filled with a fluid (e.g., a liquid) such that first electrode 103 can participate in one or more electrochemical reactions involving component(s) of the fluid. For example, first electrode 103 may be an electrically conductive solid at least a portion of which is exposed to an interior volume of first chamber 102 such that fluid (e.g., liquid) that enters the interior volume can contact at least a portion of first electrode 103. The first electrode may have any of a variety of configurations and may be made of any of a variety of materials suitable for participating in electron transfer reactions (e.g., in an electrochemical flow cell). For example, the first electrode may comprise an electrically conductive solid (e.g., an electrically conductive metal and/or metal alloy, an electrically conductive carbonaceous material such as graphite, and/or an electrically conductive polymer). As elaborated below, in some, but not necessarily all embodiments, the first electrode is a photoelectrode.

In some embodiments, the first electrode (e.g., first electrode 103) is a cathode. For example, during operation of first electrochemical cell 101, first electrode 103 may reduce (e.g., transfer electrons to) one or more components at least partially dissolved and/or suspended in a fluid mixture (e.g., a catholyte) within first chamber 102. For example, upon illumination of the first electrode and/or the second electrode (e.g., as described below), first electrode 103 may cause deactivated electroactive sorbent in first chamber 102 to be reduced and thereby generate activated electroactive sorbent.

In some embodiments, the first chamber comprises an inlet configured to receive a fluid mixture comprising a deactivated electroactive sorbent. For example, inlet 104 of system 100 in FIGS. 1A-2C may be configured to receive stream 105 comprising deactivated electroactive sorbent, which may subsequently be converted to activated electroactive sorbent in first chamber 102 upon participation in a reduction or oxidation reaction involving first electrode 103 (e.g., via contact between the fluid mixture and first electrode 103). In some embodiments, inlet 104 is fluidically connected to a source of the fluid mixture comprising deactivated electroactive sorbent (e.g., at least partially dissolved in the fluid mixture). As shown in the example embodiments in FIGS. 2A-2C, the source may be part of system 100 (e.g., a vessel such as release tank 106 where deactivated electroactive sorbent regenerated from activated electroactive sorbent is collected and/or formed). As one example, release tank 106 may comprise outlet 107 fluidically connected to inlet 104 (e.g., via one or more conduits) such that at least some (e.g., at least 10 wt %, at least 25 wt %, at least 50 wt %, at least 75 wt %, at least 90 wt %, at least 95 wt %, at least 98 wt %, at least 99 wt % or all) deactivated electroactive sorbent in release tank 106 can be transported out of outlet 107 and to inlet 104 as part of stream 105. However, in some embodiments, the source of the deactivated electroactive sorbent is external to system 100 (e.g., an external tank containing deactivated electroactive sorbent as a feedstock).

In some embodiments, the first chamber is a cathode flow chamber. The fluid mixture comprising the deactivated electroactive sorbent may form at least a portion of a catholyte. In some embodiments, the cathode flow chamber contacts the catholyte with the first electrode (e.g., a cathode). In some instances, upon illumination, the electrode reduces the catholyte (e.g., at an interface with the first electrode, which may be a photocathode).

In some embodiments, the first chamber comprises an outlet configured to output a fluid mixture comprising an activated electroactive sorbent generated at least in part via an electron transfer reaction involving the first electrode. For example, at least some (e.g., at least 10 wt %, at least 25 wt %, at least 50 wt %, at least 75 wt %, at least 90 wt %, at least 95 wt %, at least 98 wt %, at least 99 wt % or all) activated electroactive sorbent generated in first chamber 102 from deactivated electroactive sorbent via an electron transfer involving first electrode 103 may exit outlet 108 of first chamber 102. Generally, an electron transfer involving an electrode may be a direct electron transfer to or from the electrode or an indirect electron transfer to or from the electrode (e.g., via a redox mediator).

In some embodiments, the electrochemical cell comprises a second chamber comprising a second electrode. The second electrode may be in electrical communication with the first electrode such that electrons can be transported through an electrically conductive solid medium (e.g., electrical wiring) from the second electrode to the first electrode and/or vice versa (e.g., as part of an electrical circuit). Referring back to FIGS. 1A-2C, first electrochemical cell 101 may comprise second chamber 109 comprising second electrode 110. First electrochemical cell 101 may comprise separator 201 (e.g., at least partially between first electrode 103 and second electrode 110). Separator 201 may be a membrane (e.g., an ion exchange membrane) configured to allow selective passage of ions between first chamber 102 and second chamber 109 for charge balance during electrochemical reactions. Separator 201 may be configured to prevent electroactive sorbent and/or acid gas from transporting between first chamber 102 and second chamber 109. For example, the separator may comprise an ion exchange membrane configured to facilitate diffusion of ions between the first chamber (e.g., a cathode flow chamber) and the second chamber (e.g., an anode flow chamber) and maintain charge neutrality.

Second chamber 109 may be a vessel having an interior volume capable of being at least partially filled with a fluid (e.g., a liquid) such that second electrode 110 can participate in one or more electrochemical reactions involving components of the fluid. For example, second electrode 110 may be an electrically conductive solid at least a portion of which is exposed to an interior volume of second chamber 109 such that fluid (e.g., liquid) that enters the interior volume can contact at least a portion of second electrode 110. The second electrode may have any of a variety of configurations and may be made of any of a variety of materials suitable for participating in electron transfer reactions (e.g., in an electrochemical flow cell). For example, the second electrode may comprise an electrically conductive solid (e.g., an electrically conductive metal and/or metal alloy, an electrically conductive carbonaceous material such as graphite, and/or an electrically conductive polymer). As elaborated below, in some but not necessarily all embodiments, the second electrode is a photoelectrode.

In some embodiments, the second electrode (e.g., second electrode 110) is an anode. For example, during operation of first electrochemical cell 101, second electrode 110 may oxidize (e.g., remove electrons from) one or more components at least partially dissolved and/or suspended in a fluid mixture (e.g., an anolyte) within second chamber 109. For example, upon illumination of the first electrode and/or the second electrode itself (see further description below), second electrode 110 may cause a counter-electrolyte to undergo an oxidation reaction from a first oxidation state to a second oxidation state (in which the counter-electrolyte has fewer electrons). The oxidation of the counter-electrolyte (e.g., dissolved in an anolyte in second chamber 109) may be part of an overall cell reaction in which deactivated electroactive sorbent in first chamber 102 is reduced to thereby generate activated electroactive sorbent.

In some embodiments, the second chamber comprises an inlet configured to receive a fluid mixture comprising counter-electrolyte in a first oxidation state. For example, inlet 111 of system 100 in FIGS. 1A-2C may be configured to receive stream 112 comprising counter-electrolyte in the first oxidation state, at least some of which may subsequently be converted to counter-electrolyte in the second (different) oxidation state in second chamber 109 upon participation in a reduction or oxidation reaction involving second electrode 110. In some embodiments, inlet 111 is fluidically connected to a source of the fluid mixture comprising counter-electrolyte in the first oxidation state (e.g., at least partially dissolved in the fluid mixture). As shown in the example embodiments in FIGS. 2A-2C, the source may be part of system 100 (e.g., a second electrochemical cell such as second electrochemical cell 113 where counter-electrolyte in the first oxidation state is regenerated from counter-electrolyte in the second oxidation state). As one example, in FIGS. 2A-2C, first chamber 114 of second electrochemical cell 113 may comprise outlet 115 fluidically connected to inlet 111 (e.g., via one or more conduits) such that at least some (e.g., at least 10 wt %, at least 25 wt %, at least 50 wt %, at least 75 wt %, at least 90 wt %, at least 95 wt %, at least 98 wt %, at least 99 wt % or all) counter-electrolyte in first chamber 114 can be transported out of outlet 115 and to inlet 111 as part of stream 112. However, in some embodiments, the source of the counter-electrolyte in the first oxidation state is external to system 100 (e.g., an external tank containing counter-electrolyte in the first oxidation state as a feedstock).

In some embodiments, the second chamber of the first electrochemical cell is an anode flow chamber. The fluid mixture comprising the counter-electrolyte in a first oxidation state may form at least a portion of an anolyte. In some embodiments, the anode flow chamber contacts the anolyte with the second electrode (e.g., an anode). In some instances, upon illumination, the electrode oxidizes the anolyte (e.g., at an interface with the second electrode, which may be a photoanode).

In some embodiments, the second chamber of the first electrochemical cell comprises an outlet configured to output a fluid mixture comprising the counter-electrolyte in the second oxidation state generated at least in part via an electron transfer reaction involving the second electrode. For example, at least some (e.g., at least 10 wt %, at least 25 wt %, at least 50 wt %, at least 75 wt %, at least 90 wt %, at least 95 wt %, at least 98 wt %, at least 99 wt % or all) counter-electrolyte in the second oxidation state generated in second chamber 109 from counter-electrolyte in the first oxidation state via an electron transfer involving second electrode 110 may exit outlet 116 of second chamber 109.

The counter-electrolyte can be any of a variety of species capable of undergoing one or more reduction and/or oxidation reactions within the solvent window of at least one liquid solvent (e.g., water, an organic solvent such as acetonitrile, dimethylsulfoxide, N,N-dimethylformamide, tetrahydrofuran, a carbonate such as propylene carbonate, or a mixture thereof, or others). The counter-electrolyte may be selected such that when the electroactive sorbent undergoes a reduction or oxidation half-reaction, the counter-electrolyte can undergo a complementary counter-half reaction so that the overall electrochemical reaction is complete. For example, in embodiments where the deactivated electroactive sorbent is reduced to form the activated electroactive sorbent (e.g., via a cathode in the first chamber), the counter-electrolyte may undergo an oxidation reaction (e.g., via an anode in the second chamber). In some embodiments where the second electrode is a photoelectrode, the counter-electrolyte has a reduction/oxidation couple situated thermodynamically in at least one solvent such that illumination of the photoelectrode with electromagnetic radiation (e.g., AM1.5) results in the counter-electrolyte undergoing an electron transfer for that reduction/oxidation couple with an externally applied voltage across the cell of less than or equal to 2 V, less than or equal to 1.5 V, less than or equal to 1.0 V, less than or equal to 0.5 V, less than or equal to 200 mV, less than or equal to 100 mV, less than or equal to 50 mV, and/or as low as 30 mV, or even without the external application of any voltage across the cell at a temperature of 25 °C.

The counter-electrolyte may be, for example, a molecular species having the properties described above. In some embodiments, the counter-electrolyte comprises a metal, metal ion, and/or metal-containing ion (e.g., a metal coordination compound). For example, the counter-electrolyte may be an iron coordination compound that is ferrocyanide (Fe(CN)₆⁴⁻) in its first oxidation state and ferricyanide (Fe(CN)₆³⁻) in its second oxidation state (or vice versa). In some embodiments the counter-electrolyte is an organic molecule (e.g., a redox-active organic molecule such as a quinone, a phenazine, a phenothiazine, a viologen, TEMPO). The counter-electrolyte may be capable of undergoing reversible electron transfer processes (e.g., outer-sphere electron transfer processes or electron transfer processes that involve bond-breaking or bond-forming processes).

In accordance with certain embodiments, at least some of the reduction/oxidation reactions described in this disclosure for promoting capture of an acid gas are light-driven. For example, in some embodiments, a deactivated electroactive sorbent or a different component is exposed to electromagnetic radiation (e.g., ultraviolet and/or visible light) such that an electron transfer reaction occurs resulting in the deactivated electroactive sorbent being converted to an activated electroactive sorbent. In some such instances, the deactivated electroactive sorbent itself is a photochemically-active compound that directly absorbs the electromagnetic radiation and as a result undergoes an electron transfer reaction. However, in other embodiments, it is the exposure of a component in redox communication with the deactivated electroactive sorbent to electromagnetic radiation that contributes to an electron transfer reaction occurring and resulting in the deactivated electroactive sorbent being converted to an activated electroactive sorbent. The component in redox communication with the deactivated electroactive sorbent (e.g., a photoelectrode or a photochemically active species) may be able to directly or indirectly transfer electrons to or from the sorbent.

For example, as mentioned above, in some embodiments, the first electrode and/or the second electrode is a photoelectrode. For example, as shown in FIG. 1A, in some embodiments where first electrode 103 is a cathode, first electrode 103 is a photocathode as indicated by illumination symbol 117. As another example, as shown in FIG. 1B, in some embodiments where second electrode 110 is an anode, second electrode 110 is a photoanode as indicated by illumination symbol 118. In some, but not necessarily all embodiments, first electrode 103 is a photocathode and second electrode 110 is a photoanode. Following the exposure to (and absorption of) electromagnetic radiation (e.g., ultraviolet and/or visible light), the photoelectrode may be able to initiate or at least contribute driving force for an electrochemical reaction. For example, the photoelectrode may be exposed to electromagnetic radiation such that the electron transfer reaction occurs resulting in a deactivated electroactive sorbent being converted to an activated electroactive sorbent within the electrochemical cell. As such, in some embodiments, the electrochemical cell is or is part of a photoelectrochemical apparatus.

The photoelectrode may comprise a semiconductor material (and in some instances be coupled to an electrically conductive current collector) that, upon illumination with photons having sufficient energy, can produce an electron-hole pair that upon separation results in electrical current that can contribute to an electrochemical reaction in the electrochemical cell. Non-limiting examples of classes of semiconductor materials that may be employed as part a photoelectrode include, but are not limited to metal oxides, phosphides, nitrides, sulfides, sulfates, and/or combinations thereof. In some embodiments, the photoelectrode comprises a photosensitizer (e.g., a molecular, polymeric, and/or solid photosensitizer). Examples of materials that may be suitable for a photoanode include, but are not limited to, hematite (α-Fe₂O3), TiO₂, BiVO₄, tantalum oxynitrides, LaTiO₂N, BaTaO₂N, SrTaO₂N, CuWO₄, ZnFe₂O₄, and/or WO₃. Examples of materials that may be suitable for a photocathode include, but are not limited to, Si, MoS₂, MoSe₂, GaP, CdS, CdSe, ZnSe, CuNbO₄, InP, WSe₂, ZnFe_{2,}O₄, CuNbO3, Cu₂O, CaFeO₂, and/or CuFeO₂.

In some embodiments involving exposure (e.g., of an electrode) to electromagnetic radiation, at least some of the radiation has a wavelength that is in the ultraviolet portion of the electromagnetic spectrum (e.g., a wavelength in the range of from 100 nm to 400 nm, such as UV-B (from 280 nm to 315 nm) and/or UV-A (from 315 nm to 400 nm). In some embodiments, at least some of the radiation has a wavelength that is in the visible portion of the electromagnetic spectrum (e.g., a wavelength in the range of from 400 nm to 700 nm). In some embodiments, at least some of the radiation has a wavelength that is in the near-infrared portion of the electromagnetic spectrum (e.g., a wavelength in the range of from 700 nm to 2500 nm). In some embodiments, at least some of the electromagnetic radiation is solar radiation. In some embodiments, at least one reaction (e.g., electron transfer reaction) is at least partially induced by an electroactive sorbent and/or a component in redox communication with the electroactive sorbent (e.g., a photoelectrode) absorbing electromagnetic radiation (e.g., radiation having at least one of the wavelength ranges described above).

Some embodiments involve capture of an acid gas directly or indirectly via a sorbent. A sorbent may be a solid or liquid material that can absorb or adsorb a target molecule or group of molecules (e.g., from an initial fluid mixture such as a gas mixture) or another component of a mixture via either a physical or chemical interaction between the targeted molecule (e.g., acid gas) and the sorbent material or via a change in proton activity of the surrounding medium.

In some cases, energy may be applied to “activate” the sorbent to promote its ability to induce capture of the target gas molecule. Energy types can include thermal energy, electricity, and/or pressure, which can be added or removed from the system to activate the sorbent.

Solid sorbents include, but are not limited to metal oxides, metal hydroxides, metal phosphates, metal carbonates, carbon-based solids, zeolites, molecular sieves, silica gels, metal organic frameworks, polyimides, phenazines, mixtures of these materials, or amine-, imidine-, pyridine-, phenazine-or quinone-functionalized versions of these materials, as well as derivatives of these compounds. In general, any of a variety of solid substrates can be functionalized with a molecule capable of physically interacting with or chemically bonding to the target acid gas molecule(s).

Liquid sorbents may include liquid forms of any of the compounds listed above, or liquid solutions that include them (e.g., as at least partially dissolved species). Similarly, physical solvents are liquids that dissolve an acid gas, thereby removing it from the initial fluid mixture (e.g., gas mixture). Liquid absorbents can include, but are not limited to various amines, ammonia-based solutions, molten metal hydroxides, molten metal carbonates, molten metal oxides, molten salts, deep eutectic solvents, solutions of amino acid salts, polyglycol ether, ionic liquids, aqueous hydroxide solutions, or aqueous inorganic solutions of basic compounds.

As discussed above, some embodiments involve the capture of an acid gas (e.g., from a fluid mixture such as a gas stream) induced at least in part by the activation of an electroactive sorbent from a deactivated state to an activated state. A sorbent that is electroactive may be capable of undergoing one or more reduction and/or oxidation reactions within the solvent window of at least one liquid solvent (e.g., water, an organic solvent such as acetonitrile, dimethylsulfoxide, N, N-dimethylformamide, tetrahydrofuran, a carbonate such as propylene carbonate, or a mixture thereof).

As a non-limiting example, if the electroactive sorbent is an optionally-substituted quinone, the neutral quinone may be considered the deactivated state, the semiquinone (product of the addition of one electron to the neutral quinone) would be considered one activated state, and the quinone dianion (the product of the addition of one electron to neutral quinone) could also be considered the activated state.

The sorbent may induce capture of the acid gas via any of a variety of mechanisms.

In some embodiments, the activated electroactive sorbent induces capture of the acid gas from the fluid mixture at least in part by bonding to the acid gas or a portion thereof. The bonding may be a reversible process that allows for subsequent electron transfer-initiated release of the acid gas as opposed to starting an irreversible reaction that converts the acid gas to a different product (e.g., CO₂ reduction to a hydrocarbon). The bonding may be via a covalent bond, an electrostatic interaction (e.g., formation of a salt bridge), hydrogen bonding, or any of a variety of other specific or non-specific non-covalent affinity interactions. In some embodiments, the bonding is via a covalent bond. As one example of covalent bonding, the acid gas may be carbon dioxide and the activated electroactive sorbent may be a quinone dianion, and an oxyanion of the quinone dianion may form a covalent bond with the carbon of the carbon dioxide, thereby forming a carbonate group covalently bound to the quinone. As another example, when the acid gas is HCl, the oxyanion of the quinone dianion may deprotonate the HCl (e.g., directly or via a chain of proton transfers involving for, example, the solvent), resulting in the formation of a covalent bond between the oxygen of the quinone and the proton, forming a hydroxy group and leaving a chloride ion in the fluid mixture (and thereby resulting in the HCl being captured). In some embodiments, the activated electroactive sorbent has a higher binding constant for bonding to the acid gas or a portion thereof than does the deactivated electroactive sorbent (e.g., by a factor of greater than or equal to 101, greater than or equal to 102, greater than or equal to 103, greater than or equal to 104, greater than or equal to 105, greater than or equal to 106, greater than or equal to 107 and/or up to 108, up to 109, or greater). This relationship may hold at at least one temperature, such as 298 κ. The greater affinity may be due to, for example, a change in oxidation state (e.g., a reduction causing an increase in electron-density on at least a portion of the sorbent resulting in an increase in basicity and/or nucleophilicity of the sorbent).

In some embodiments, the activated electroactive sorbent induces capture of the acid gas at least in part by causing one or more proton transfers involving at least some of the removed activated electroactive sorbent and/or the acid gas. The activation of the electroactive sorbent state from its deactivated state may cause one or more proton transfers by, for example, the activated electroactive sorbent having a different pKₐ than the deactivated electroactive sorbent. In some such embodiments, the activated electroactive sorbent has a higher pKₐ in water at 298 κ than does the deactivated electroactive sorbent. For example, the activated electroactive sorbent may have a pKₐ in water at 298 κ that is greater than that of the deactivated electroactive sorbent by at least 0.5, at least 1.0, at least 2.0, at least 5.0, at least 10.0, and/or up to 12.0, up to 14.0 or greater. The activation of the electroactive sorbent may result in a change in the pH (e.g., an increase) of the fluid mixture in which the electroactive sorbent is present. In some such instances, the change in pH may induce capture of the acid gas (e.g., by shifting of dissolution and/or chemical equilibria and/or causing the acid gas or an acid formed by the acid gas to become deprotonated in solution) once the acid gas is exposed to the solution having the increased pH. As a specific but non-limiting example, a (photo-)electrochemically induced increase in the pH of a liquid in which the sorbent is present may increase the extent to which carbon dioxide dissolves into the liquid from a gas mixture due to the underlying acid-base equilibria involving carbon dioxide, carbonic acid, bicarbonate anion, and carbonate dianion.

Any of a variety of electroactive sorbents may be employed, provided that they have at least the common quality of being able to convert between an activated state and a deactivated state via one or more electron transfer reactions as described in this disclosure to induce capture of an acid gas. In some embodiments, the electroactive sorbent is selected based on its affinity in its activated state for one or more acid gases (e.g., carbon dioxide). In some embodiments, the electroactive sorbent is selected based on an ability to form a strong nucleophile or strong base upon reduction. In some embodiments, the electroactive sorbent is selected at least in part based on its solubility in a desired liquid (e.g., aqueous solutions).

In some embodiments, the electroactive sorbent is or comprises an organic species. The species may be optionally-substituted (e.g., the species may comprise functional groups and/or other moieties or linkages bonded to the main structure of the species). In some embodiments, the organic species comprises one or more species chosen from optionally-substituted quinone, optionally-substituted thiolate, an optionally-substituted pyridine, an optionally-substituted bipyridine, an optionally-substituted phenazine, an optionally-substituted phenothiazine, and/or a redox-active amine.

In certain cases, the electroactive sorbent is or comprises a redox-active polymer comprising an optionally-substituted organic species. The choice of substituent (e.g., functional groups) on the optionally-substituted species may depend on any of a variety of factors, including but not limited to its effect on the pKₐ and/or the standard reduction potential of the optionally-substituted species, and/or the solubility of the resulting species. With the benefit of this disclosure, it can be determined which substituents or combinations of substituents on the optionally-substituted species (e.g., quinone) are suitable for the electroactive sorbent based on, for example synthetic feasibility, and resulting pKₐ and/or standard reduction potential.

In some embodiments, the optionally-substituted quinone is or comprises an optionally-substituted naphthoquinone. In certain cases, the optionally-substituted quinone is or comprises an optionally-substituted anthraquinone. In some embodiments, the optionally-substituted quinone is or comprises an optionally-substituted quinoline. In some embodiments, the optionally-substituted quinone is or comprises an optionally-substituted thiochromene-dione. In some embodiments, the optionally-substituted quinone is one of benzo[g]quinoline-5,10-dione, benzo[g]isoquinoline-5,10-dione, benzo[g]quinoxaline-5,10-dione, quinoline-5,8-dione, or 1-lamba⁴-thiochromene-5,8-dione. In some embodiments, the optionally-substituted quinone is or comprises an optionally-substituted phenanthrenequinone (also referred to as an optionally-substituted phenanthrenedione). The substituents (e.g., functional groups) may be any of those listed above or below.

As mentioned above, the electroactive sorbent may be part of a redox-active polymer. In some cases, any of the optionally-substituted species (e.g., organic species) described herein may be part of the redox-active polymer. In some such cases, at least a portion of the redox-active polymer comprises a backbone chain and one or more of the optionally-substituted species covalently bonded to the backbone chain. A backbone chain generally refers to the longest series of covalently bonded atoms that together create a continuous chain of the polymer molecule. In certain other cases, the optionally-substituted species described herein may be part of the backbone chain of the redox-active polymer. The polymer may be immobilized on an electrode in some, but not necessarily all embodiments.

Exemplary functional groups with which the optionally-substituted quinone may be functionalized include, but are not limited to, halo (e.g., chloro, bromo, iodo), hydroxyl, carboxylate/carboxylic acid, sulfonate/sulfonic acid, alkylsulfonate/alkylsulfonic acid, phosphonate/phosphonic acid, alkylphosphonate/alkylphosphonic acid, acyl (e.g., acetyl, ethyl ester, etc.), amino, amido, quaternary ammonium (e.g., tetraalkylamino), branched or unbranched alkyl (e.g., C₁-C₁₈ alkyl), heteroalkyl, alkoxy, glycoxy, polyalkyleneglycoxy (e.g., polyethyleneglycoxy), imino, polyimino, branched or unbranched alkenyl, branched or unbranched alkynyl, aryl, heteroaryl, heterocyclyl, nitro, nitrile, thiyl, and/or carbonyl groups, any of which is optionally-substituted. The above-mentioned functional groups may also be employed in any of the other types of electroactive sorbents described herein (e.g., optionally-substituted thiolate, an optionally-substituted bipyridine, an optionally-substituted phenazine, and an optionally-substituted phenothiazine). As would be understood by a person of ordinary skill in the art, a heteroaryl substitution of an aromatic species such as a quinone may be a ring fused with the aromatic species. For example, a quinone functionalized with a heteroaryl group can be a quinoline-dione (e.g., a benzoquinoline-dione). Heteroatoms in rings that are part of electroactive sorbent, may, in some instances, affect the pKₐ of a reduced form of the electroactive sorbent and/or its standard reduction potential. For example, a quinoline-dione may have a more positive standard reduction potential than a naphthoquinone, and a quinoxaline-dione may have a more positive standard reduction potential than the quinoline-dione.

Non-limiting examples of electroactive sorbents that can capture acid gases include, but are not limited to those described in U.S. Patent Application Publication No. 2021-0060485, entitled “Electrochemical Capture of Lewis Acid Gases,” published on Mar. 4, 2021, filed as U.S. patent application Ser. No. 17/005,250 on Aug. 27, 2020; and U.S. Patent Application Publication No. 2021-0062351, entitled “Electrochemically Mediated Gas Capture, Including from Low Concentration Streams,” published on Mar. 4, 2021, filed as U.S. patent application Ser. No. 17/005,243 on Aug. 27, 2020, each of which is incorporated herein by reference it its entirety for all purposes.

The capture of an acid gas generally does not involve the irreversible conversion of the acid gas into a different compound (e.g., having a different oxidation state). For example, in the case of CO₂, the field of CO₂ “capture” is notably distinct from CO₂ “conversion.” In this latter case of CO₂ conversion, CO₂ that has already been captured from a fluid mixture (e.g., a gas mixture) is converted into a different compound via a chemical reaction, examples of which include: carbon monoxide (CO); methanol (CH₃OH) and/or higher carbon chain alcohols like ethanol (C₂H₆O) and propanol (C₃H₈O); various ethers such as dimethyl ether (C₂H₆O) and/or other polyoxymethylene dimethyl ethers (H₃CO(CH₂O)ₙCH₃); and/or olefins of various carbon chain length such as ethylene (C₂H₄), propylene (C₃H₆), and/or butadiene (C₄H₆). Conversion of CO₂ to other carbon-based compounds is also possible. As such, CO₂ capture systems may in some instances precede CO₂ conversion systems. In general, the same distinction between “capture” and “conversion” can be made for all acid gases. Examples of methods for the capture of acid gases from mixed gas streams include the use of solid or liquid sorbent materials, liquid solvents, phase manipulation, or membrane technologies.

Any of a variety of acid gases may be captured. In some instances, the acid gas is a gaseous species at 298 κ and 1 atm. It should be understood that while acid gas is described as being a gas, the acid gas may be dissolved in a liquid during at least a portion of the method. For example, in some embodiments in which the acid gas is carbon dioxide, a gaseous stream of carbon dioxide may be bubbled into a liquid solution (e.g., an aqueous liquid solution) comprising dissolved electroactive sorbent (e.g., in its activated state), and a portion of the bubbled carbon dioxide may dissolve in the liquid solution and encounter the sorbent (e.g., for capture).

In some embodiments, the acid gas comprises a Lewis acid. In some embodiments, the acid gas is an aprotic acid gas. In some embodiments, the acid gas comprises carbon dioxide. In some embodiments, the acid gas comprises a Brønsted-Lowry acid or an anhydride of a Brønsted-Lowry acid. A Brønsted-Lowry acid refers to any species that can donate a proton (H⁺) to another species. Examples of anhydrides of Brønsted-Lowry acids include, but are not limited to carbon dioxide (which can form the Brønsted-Lowry acid carbonic acid upon addition of water), sulfur dioxide (which can form the Brønsted-Lowry acid sulfurous acid upon addition of water), sulfur trioxide (which can form the Brønsted-Lowry acid sulfuric acid upon addition of water), and N₂O₅ (which can form the Brønsted-Lowry acid nitric acid upon addition of water). In some embodiments, acid gas is a sulfur-containing species (e.g., a gaseous sulfur oxide species). In some embodiments, the acid gas comprises a nitrogen-containing species (e.g., a gaseous nitrogen oxide species). In some embodiments, the acid gas comprises one or more boranes (e.g., BH₃). In some embodiments, the acid gas comprises a hydride of a halogen (e.g., HF, HCl, HBr, HI). In some embodiments, the acid gas comprises CO₂, SOₓ, NOₓ, H₂S, HF, HCl, HBr, HI, a borane, and/or Cl₂O.

In some embodiments, the acid gas comprises carbon dioxide, the deactivated electroactive sorbent comprises an optionally-substituted quinone dissolved in a catholyte solution, the first electrode is a cathode in a cathode flow chamber, the second electrode is a photoanode (e.g., comprising a semiconductor) in an anode flow chamber, and the counter-electrolyte is a redox-active molecule (e.g., a metal coordination compound) dissolved in an anolyte solution.

In some embodiments, at least some (e.g., at least 10 wt %, at least 25 wt %, at least 50 wt %, at least 75 wt %, at least 90 wt %, at least 95 wt %, at least 98 wt %, at least 99 wt % or all) of the activated electroactive sorbent (e.g., generated in the first chamber) is removed from the electrochemical cell. The removal of the activated electroactive sorbent may occur prior to the generated activated electroactive sorbent being exposed to the acid gas. In some instances, at least some (e.g., at least 10 wt %, at least 25 wt %, at least 50 wt %, at least 75 wt %, at least 90 wt %, at least 95 wt %, at least 98 wt %, at least 99 wt % or all) of the acid gas ultimately exposed to activated electroactive sorbent is first exposed to the activated electroactive sorbent outside of the electrochemical cell.

One way in which the activated electroactive sorbent may be exposed to the acid gas in a location other than the electrochemical cell is in a contactor. In this context, a “contactor” generally refers to any arrangement of flows that allows contact between the fluid mixture (e.g., liquid) comprising the activated electroactive sorbent and the fluid mixture (e.g., gas stream) comprising the acid gas. In some instances, the contactor comprises a vessel. For example, the contactor may comprise a vessel external and separate from the electrochemical cell and configured to expose a fluid mixture comprising the activated electroactive sorbent removed from the electrochemical cell to a fluid mixture comprising the acid gas. Referring to FIGS. 1A-2C, system 100 may comprise contactor 119 configured to expose activated electroactive sorbent generated in and removed from first chamber 102 to a fluid mixture comprising an acid gas. The contactor may have any of a variety of configurations. For example, the contactor may comprise a gas-liquid contactor. Examples of types of contactors that may be employed in at least some embodiments include, but are not limited to a falling-film column, a packed column, a bubble column, a spray tower, a gas-liquid agitated vessel, a hollow-fibre, a plate column, a rotating disc contactor, and/or a Venturi tube.

The contactor may comprise a sorbent inlet configured to receive a fluid mixture comprising activated electroactive sorbent. For example, contactor 119 comprises sorbent inlet 120 fluidically connected to outlet 108 of first chamber 102 such that at least some (e.g., at least 10 wt %, at least 25 wt %, at least 50 wt %, at least 75 wt %, at least 90 wt %, at least 95 wt %, at least 98 wt %, at least 99 wt % or all) activated electroactive sorbent can be transported from outlet 108 to sorbent inlet 120 as part of stream 121 (e.g., via one or more conduits).

In some embodiments, the contactor comprises an acid gas inlet configured to receive the fluid mixture comprising the acid gas. For example, contactor 119 comprises acid gas inlet 221, which can receive a fluid mixture (e.g., gas mixture) comprising the acid gas as part of stream 122, according to some embodiments. Contactor 119 may be fluidically connected to a source of the fluid mixture comprising the acid gas (e.g., a source external to the system such as effluent from an industrial process or even ambient air).

In some embodiments, the contactor comprises an outlet configured to output captured acid gas (e.g., acid gas bonded to activated electroactive sorbent and/or dissolved in liquid at least in part due to a change in proton activity (e.g., pH) of the liquid caused by activation of the electroactive sorbent). For example, referring again to FIGS. 1A-2C, contactor 119 may comprise outlet 123 configured to output captured acid gas as part of stream 124 (e.g., a liquid stream).

In some, but not necessarily all embodiments, contactor 119 comprises outlet 125 configured to output a fluid mixture (e.g., a gas mixture) as part of stream 126, with the fluid mixture having no acid gas or a lower amount of the acid gas than the fluid mixture comprising the acid gas fed into acid gas inlet 221 (e.g., by a factor of at least 1.05, at least 1.1, at least 1.2, at least 1.5, at least 2, at least 5, at least 10, at least 20, at least 50, at least 100, and/or up to 200, up to 500, up to 1000 or more). For example, in some embodiments, a gas mixture comprising an amount of carbon dioxide is fed to the acid gas inlet of the contactor. Upon exposure to activated electroactive sorbent, at least some (e.g., at least 10 wt %, at least 25 wt %, at least 50 wt %, at least 75 wt %, at least 90 wt %, at least 95 wt %, at least 98 wt %, at least 99 wt % or all) of the carbon dioxide is removed from the gas stream such that when the gas stream exits the contactor via the outlet, the gas stream has no carbon dioxide or a smaller amount of carbon dioxide than prior to being input into the contactor.

Removing the activated electroactive sorbent from the electrochemical cell (e.g., first electrochemical cell 101) and exposing the activated electroactive sorbent to the fluid mixture comprising the acid gas in a location external to the electrochemical cell (e.g., a separate contactor) may have any of a variety of advantages in at least some embodiments.

For example, the acid gas capture (e.g., CO₂ capture) can be spatially decoupled from the electrochemical cell. This may allow for the operational advantage where a distributed network of contactors (e.g., CO₂ contactors) can be judiciously placed in areas where acid gas (e.g., CO₂) is to be captured, since the contactor (e.g., CO₂ contactor) is spatially separated from the electrochemical cell where the sorbent is activated to capture the acid gas (e.g., CO₂), or deactivated (e.g., oxidized) to release CO₂ (as is described for some embodiments below). This may allow for improved economics and energetics because economies of scale can be leveraged in the electrochemical cell, while simultaneously allowing for a more advantageously distributed capture of the acid gas (e.g., CO₂). This may translate into an operational advantage in some embodiments since there can be a single point of acid gas (e.g., CO₂) collection for storage or conversion at a centralized electrochemical cell, while being able to capture acid gas (e.g., CO₂) from a distributed network of contactors.

In some embodiments, captured acid gas is released (e.g., into a fluid stream such as a gas stream). For example, in some instances acid gas bonded to activated electroactive sorbent in a liquid solution is released via the breaking of the chemical bond. The release (e.g., by breaking of the chemical bond) may be induced in any of a variety of ways. For example, a chemical process (e.g., electrochemical process) may convert the activated electroactive sorbent bonded to the captured acid gas back to deactivated electroactive sorbent (or to a different state altogether) such that the bond between the sorbent and the acid gas is broken, thereby forming acid gas free to leave the fluid mixture in which the sorbent is present. As another example, in embodiments where the capture of the acid gas involves inducing dissolution of the acid gas in liquid via a change in proton activity (e.g., a change in pH), the proton activity in the liquid may be adjusted to a level that results in an amount of the dissolved acid gas being converted to gaseous acid gas that can leave the solution (e.g., into a gas stream). For example, the pH may be lowered.

In some embodiments, release of the captured acid gas is induced at least in part via an electrochemical process. The electrochemical process (e.g., involving one or more electron transfers) may occur in the first electrochemical cell. For example, an adduct of activated electroactive sorbent and captured acid gas may be transported into the second chamber of the first electrochemical cell and one or more electron transfers involving the second electrode may be induced (e.g., at least in part via exposure of the second electrode to electromagnetic radiation such as ultraviolet and/or visible light). The electron transfer may result in the conversion of activated electroactive sorbent to deactivated electroactive sorbent, thereby breaking up the adduct and freeing the acid gas, which may be then transported out of the second chamber.

In some such embodiments, the system comprises only a single electrochemical cell configured to perform both activation and deactivation of the sorbent (e.g., to induce capture and release, respectively). However in some embodiments, the system comprises multiple electrochemical cells, as described in more detail below.

In some embodiments, the system comprises a first electrochemical cell and a second electrochemical cell. For example, in the embodiments shown in FIGS. 2A-2C , system 100 comprises first electrochemical cell 101 and second electrochemical cell 113. Second electrochemical cell 113 may, in some instances, be configured to induce release of captured acid gas. Further, in some instances, second electrochemical cell 113 is configured to regenerate deactivated electroactive sorbent.

In some embodiments, the second electrochemical cell comprises a first chamber comprising a first electrode. For example, referring back to FIGS. 2A-2C , second electrochemical cell 113 may comprise first chamber 114 comprising first electrode 127. First chamber 114 may be a vessel having an interior volume capable of being at least partially filled with a fluid (e.g., a liquid) such that first electrode 127 can participate in one or more electrochemical reactions involving components of the fluid. For example, first electrode 127 may be an electrically conductive solid at least a portion of which is exposed to an interior volume of first chamber 114 such that fluid (e.g., liquid) that enters the interior volume can contact at least a portion of first electrode 127. The first electrode of the second electrochemical cell may have any of a variety of configurations and may be made of any of a variety of materials suitable for participating in electron transfer reactions (e.g., in an electrochemical flow cell). For example, the first electrode may comprise an electrically conductive solid (e.g., an electrically conductive metal and/or metal alloy, an electrically conductive carbonaceous material such as graphite, and/or an electrically conductive polymer). As elaborated below, in some, but not necessarily all embodiments, the first electrode of the second electrochemical cell is a photoelectrode.

In some embodiments, the first electrode of the second electrochemical cell (e.g., first electrode 127) is a cathode. For example, during operation of second electrochemical cell 113, first electrode 127 may reduce (e.g., transfer electrons to) one or more components at least partially dissolved and/or suspended in a fluid mixture (e.g., a catholyte) within first chamber 114. For example, upon illumination of the first electrode and/or the second electrode described below, first electrode 127 may cause counter-electrolyte in the second oxidation state (e.g., previously generated in second chamber 109 of first electrochemical cell 101) present in first chamber 114 to be reduced and thereby generate counter-electrolyte in the first oxidation state (the first oxidation being lower than the second oxidation in this example).

In some embodiments, the first chamber of the second electrochemical cell comprises an inlet configured to receive a fluid mixture comprising counter-electrolyte in the second oxidation state. For example, inlet 128 of system 100 in FIGS. 2A-2C may be configured to receive stream 129 comprising counter-electrolyte in the second oxidation state, which may subsequently be converted to counter-electrolyte in the first oxidation state in first chamber 114 upon participation in a reduction or oxidation reaction involving first electrode 127. In some embodiments, inlet 128 is fluidically connected to outlet 116 of second chamber 109 of first electrochemical cell 101 (e.g., via one or more conduits). The fluidic connection may be configured such that at least some (e.g., at least 10 wt %, at least 25 wt %, at least 50 wt %, at least 75 wt %, at least 90 wt %, at least 95 wt %, at least 98 wt %, at least 99 wt % or all) counter-electrolyte in the second oxidation state can be transported out of outlet 116 and to inlet 128 as part of stream 129.

In some embodiments, the first chamber of the second electrochemical cell comprises an outlet configured to output a fluid mixture comprising counter-electrolyte in the first oxidation state generated at least in part via an electron transfer reaction involving the first electrode of the second electrochemical cell. For example, at least some (e.g., at least 10 wt %, at least 25 wt %, at least 50 wt %, at least 75 wt %, at least 90 wt %, at least 95 wt %, at least 98 wt %, at least 99 wt % or all) counter-electrolyte in the first oxidation state generated in first chamber 114 from counter-electrolyte in the second oxidation via an electron transfer involving first electrode 127 may exit outlet 115 of first chamber 114. As mentioned above, in some embodiments, the outlet (e.g., outlet 115) of the first chamber of the second electrochemical cell may be fluidically connected to the inlet (e.g., inlet 111) of the second chamber of the first electrochemical cell (e.g., via one or more conduits).

In some embodiments, the second electrochemical cell comprises a second chamber comprising a second electrode. The second electrode may be in electrical communication with the first electrode of the second electrochemical cell such that electrons can be transported through an electrically conductive solid medium (e.g., electrical wiring) from the second electrode to the first electrode and/or vice versa (e.g., as part of an electrical circuit). Referring back to FIGS. 2A-2C , second electrochemical cell 113 may comprise second chamber 130 comprising second electrode 131. Second electrochemical cell 113 may comprise separator 202 (e.g., at least partially between first electrode 127 and second electrode 131). Separator 202 may be a membrane (e.g., ion exchange membrane) configured to allow selective passage of ions between first chamber 114 and second chamber 130 for charge balance during electrochemical reactions. Separator 202 may be configured to prevent electroactive sorbent and/or acid gas from transporting between first chamber 114 and second chamber 130.

Second chamber 130 of second electrochemical cell 113 may be a vessel having an interior volume capable of being at least partially filled with a fluid (e.g., a liquid) such that second electrode 131 can participate in one or more electrochemical reactions involving components of the fluid. For example, second electrode 131 may be an electrically conductive solid at least a portion of which is exposed to an interior volume of second chamber 130 such that fluid (e.g., liquid) that enters the interior volume can contact at least a portion of second electrode 131. The second electrode may have any of a variety of configurations and may be made of any of a variety of materials suitable for participating in electron transfer reactions (e.g., in an electrochemical flow cell). For example, the second electrode may comprise an electrically conductive solid (e.g., an electrically conductive metal and/or metal alloy, an electrically conductive carbonaceous material such as graphite, and/or an electrically conductive polymer). As elaborated below, in some, but not necessarily all embodiments, the second electrode of the second electrochemical cell is a photoelectrode.

In some embodiments, the second electrode (e.g., second electrode 131) of the second electrochemical cell is an anode. For example, during operation of second electrochemical cell 113, second electrode 131 may oxidize (e.g., remove electrons from) one or more components at least partially dissolved and/or suspended in a fluid mixture (e.g., an anolyte) within second chamber 130. For example, upon illumination of the first electrode and/or the second electrode itself (see further description below), second electrode 131 may cause activated electroactive sorbent (e.g., in an adduct with captured acid gas) to undergo an oxidation reaction to generate deactivated electroactive sorbent. The oxidation of the activated electroactive sorbent (e.g., dissolved in an anolyte in second chamber 130) may be part of an overall cell reaction in which counter-electrolyte in the second oxidation state in first chamber 114 is reduced, thereby generating counter-electrolyte in the first oxidation state.

In some embodiments, the second chamber of the second electrochemical cell comprises an inlet configured to receive a fluid mixture comprising at least some (e.g., at least 10 wt %, at least 25 wt %, at least 50 wt %, at least 75 wt %, at least 90 wt %, at least 95 wt %, at least 98 wt %, at least 99 wt % or all) of the activated electroactive sorbent and at least some (e.g., at least 10 wt %, at least 25 wt %, at least 50 wt %, at least 75 wt %, at least 90 wt %, at least 95 wt %, at least 98 wt %, at least 99 wt % or all) of the captured acid gas output from the contactor. For example, inlet 132 of system 100 in FIGS. 2A-2C may be configured to receive at least some (e.g., at least 10 wt %, at least 25 wt %, at least 50 wt %, at least 75 wt %, at least 90 wt %, at least 95 wt %, at least 98 wt %, at least 99 wt % or all) of stream 124 comprising activated electroactive sorbent and captured acid gas (which may be complexed with each other). At least some (e.g., at least 10 wt %, at least 25 wt %, at least 50 wt %, at least 75 wt %, at least 90 wt %, at least 95 wt %, at least 98 wt %, at least 99 wt % or all) of the activated electroactive sorbent may subsequently be converted to deactivated electroactive sorbent in second chamber 130 upon participation in an electron transfer reaction (e.g., a reduction or oxidation reaction) involving second electrode 131, thereby inducing release of at least some (e.g., at least 10 wt %, at least 25 wt %, at least 50 wt %, at least 75 wt %, at least 90 wt %, at least 95 wt %, at least 98 wt %, at least 99 wt % or all) of the acid gas.

In some embodiments, inlet 132 is fluidically connected to a source of the fluid mixture comprising at least some of the activated electroactive sorbent and at least some of the captured acid gas. As one example, in FIGS. 2A-2C, contactor 119 may comprise outlet 123 fluidically connected to inlet 132 (e.g., via one or more conduits) such that at least some (e.g., at least 10 wt %, at least 25 wt %, at least 50 wt %, at least 75 wt %, at least 90 wt %, at least 95 wt %, at least 98 wt %, at least 99 wt % or all) activated electroactive sorbent and at least some (e.g., at least 10 wt%, at least 25 wt%, at least 50 wt %, at least 75 wt %, at least 90 wt %, at least 95 wt %, at least 98 wt %, at least 99 wt % or all) captured acid gas output from contactor 119 can be transported out of outlet 123 and to inlet 132 as part of stream 124.

In some embodiments, the second chamber of the second electrochemical cell comprises an outlet configured to output released acid gas (e.g., as part of a fluid mixture also comprising at least some deactivated electroactive sorbent generated at least in part via an electron transfer reaction involving the second electrode (e.g., upon exposure to electromagnetic radiation such as ultraviolet and/or visible light)). For example, at least some (e.g., at least 10 wt %, at least 25 wt %, at least 50 wt %, at least 75 wt %, at least 90 wt %, at least 95 wt %, at least 98 wt %, at least 99 wt % or all) acid gas released (e.g., from the electroactive sorbent) and/or at least some (e.g., at least 10 wt%, at least 25 wt %, at least 50 wt %, at least 75 wt %, at least 90 wt %, at least 95 wt %, at least 98 wt %, at least 99 w t% or all) deactivated electroactive sorbent generated in second chamber 130 from activated electroactive sorbent via an electron transfer involving second electrode 131 may exit outlet 133 of second chamber 130 (e.g., as part of stream 134). Outlet 133 may be fluidically connected to inlet 135 of release tank 106 such that at least some (e.g., at least 10 wt %, at least 25 wt %, at least 50 wt %, at least 75 wt %, at least 90 wt %, at least 95 wt %, at least 98 wt %, at least 99 wt % or all) released acid gas can be transported from outlet 133 to inlet 135. Release tank 106 may collect released acid gas which may then be released. For example, release tank 106 may be configured to release a fluid mixture (e.g., gas stream) rich in released acid gas as part of stream 136. Stream 136 may comprise the acid gas in an amount of at least 10 wt %, at least 25 wt%, at least 50 wt %, at least 75 wt %, at least 90 wt %, at least 95 wt %, at least 98 wt %, at least 99 wt %, or 100 wt %.

As mentioned above, at least some of the reduction/oxidation reactions described in this disclosure for promoting release of the acid gas are light-driven, in accordance with certain embodiments. For example, in some embodiments, an activated electroactive sorbent or a different component is exposed to electromagnetic radiation (e.g., ultraviolet and/or visible light) such that an electron transfer reaction occurs resulting in the activated electroactive sorbent being converted to a deactivated electroactive sorbent (e.g., thereby inducing release of captured acid gas). In some such instances, the activated electroactive sorbent itself is a photochemically-active compound that directly absorbs the electromagnetic radiation and as a result undergoes an electron transfer reaction. However, in other embodiments, it is the exposure of a component in redox communication with the activated electroactive sorbent to electromagnetic radiation that contributes to an electron transfer reaction occurring and resulting in the activated electroactive sorbent being converted to a deactivated electroactive sorbent.

The component in redox communication with the activated electroactive sorbent (e.g., a photoelectrode or a photochemically active species) may be able to directly or indirectly transfer electrons to or from the sorbent.

For example, as mentioned above, in some embodiments, the first electrode and/or the second electrode of the second electrochemical cell is a photoelectrode. For example, as shown in FIG. 2A, in some embodiments where first electrode 127 is a cathode, first electrode 127 is a photocathode as indicated by illumination symbol 137. As another example, as shown in FIG. 2B, in some embodiments where second electrode 131 is an anode, second electrode 131 is a photoanode as indicated by illumination symbol 138. In some, but not necessarily all embodiments, first electrode 127 is a photocathode and second electrode 131 is a photoanode. In some embodiments, as illustrated in FIG. 2C, second electrode 110 of first electrochemical cell 101 and second electrode 131 of second electrochemical cell 113 are both photoelectrodes.

As used herein, two elements are in fluidic communication with each other (or, equivalently, in fluid communication with each other) when fluid may be transported from one of the elements to the other of the elements without otherwise altering the configurations of the elements or a configuration of an element between them (such as a valve). Two conduits connected by an open valve (thus allowing for the flow of fluid between the two conduits) are considered to be in fluidic communication with each other. In contrast, two conduits separated by a closed valve (thus preventing the flow of fluid between the conduits) are not considered to be in fluidic communication with each other.

As used herein, two elements are fluidically connected to each other when they are connected such that, under at least one configuration of the elements and any intervening elements, the two elements are in fluidic communication with each other. An outlet and an inlet connected by a valve and conduits that permit flow between the outlet and the inlet in at least one configuration of the valve would be said to be fluidically connected to each other. To further illustrate, an outlet and an inlet that are connected by a valve and conduits that permit flow between the outlet and the inlet in a first valve configuration but not a second valve configuration are considered to be fluidically connected to each other both when the valve is in the first configuration and when the valve is in the second configuration. In contrast, an outlet and an inlet that are not connected to each other (e.g., by a valve, another conduit, or another component) in a way that would permit fluid to be transported between them under any configuration would not be said to be fluidically connected to each other. Elements that are in fluidic communication with each other are always fluidically connected to each other, but not all elements that are fluidically connected to each other are necessarily in fluidic communication with each other.

Various components are described herein as being fluidically connected. Fluidic connections may be either direct fluidic connections or indirect fluidic connections.

Generally, a direct fluidic connection exists between a first region and a second region (and the two regions are said to be directly fluidically connected to each other) when they are fluidically connected to each other and when the composition of the fluid at the second region of the fluidic connection has not substantially changed relative to the composition of the fluid at the first region of the fluidic connection (i.e., no fluid component that was present in the first region of the fluidic connection is present in a weight percentage in the second region of the fluidic connection that is more than 5% different from the weight percentage of that component in the first region of the fluidic connection). As an illustrative example, a stream that connects first and second unit operations, and in which the pressure and temperature of the fluid is adjusted but the composition of the fluid is not altered, would be said to directly fluidically connect the first and second unit operations. If, on the other hand, a separation step is performed and/or a chemical reaction is performed that substantially alters the composition of the stream contents during passage from the first component to the second component, the stream would not be said to directly fluidically connect the first and second unit operations. In some embodiments, a direct fluidic connection between a first region and a second region can be configured such that the fluid does not undergo a phase change from the first region to the second region. In some embodiments, the direct fluidic connection can be configured such that at least 50 wt % (or at least 75 wt %, at least 90 wt %, at least 95 wt %, or at least 98 wt %) of the fluid in the first region is transported to the second region via the direct fluidic connection. Any of the fluidic connections described herein may be, in some embodiments, direct fluidic connections. In other cases, the fluidic connections may be indirect fluidic connections.

### EXAMPLE EMBODIMENT

### Section 1.0 Technical Description

This Example Embodiment describes: (1) a method for capturing acid gases using a light-mediated apparatus; (2) a photoelectrochemical apparatus that facilitates the activation of the ability of the system to capture acid gases upon illumination with light; and (3) a system for capturing acid gases that includes the light-mediated apparatus and auxiliary process components. The method, apparatus, and system are detailed below, and preliminary data demonstrating the light-mediated capture of CO2 from a fluid gas mixture is presented.

### Section 1.1 a Method for Capturing Acid Gases Using a Light-mediated Apparatus

One embodiment of the method for capturing acid gases using a light-mediated apparatus includes the illumination of a photoelectrochemical apparatus (or “photoelectrochemical cell”) which subsequently drives the reduction of a redox-active species (the “capture media”) that, when brought into contact with a fluid gas mixture containing an acid gas, is able to capture the acid gas and thereby remove it from the fluid gas mixture. The release of the captured gas from the redox-active species may be facilitated in a second photoelectrochemical apparatus that, upon illumination, is able to drive the oxidation of the redox-active species to release the gas from the capture media. In some embodiments, the redox-active species may be present as a component in an electrolyte solution, or may comprise the liquid electrolyte on its own, and may capture and/or release the acid gas by virtue of either changing the pH of an electrolyte solution, or by chemically binding to the acid gas molecule.

Illumination may be carried out using light from concentrated or unconcentrated natural solar insolation, by electrically driven light emitting diode or incandescent bulbs, or by incandescence induced by the elevated temperature of metallic or ceramic materials.

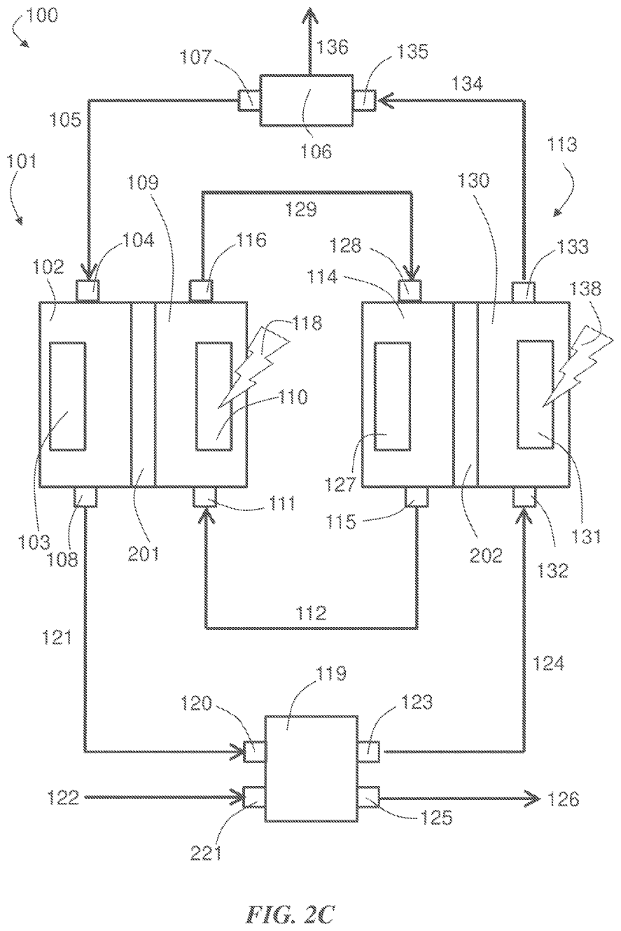

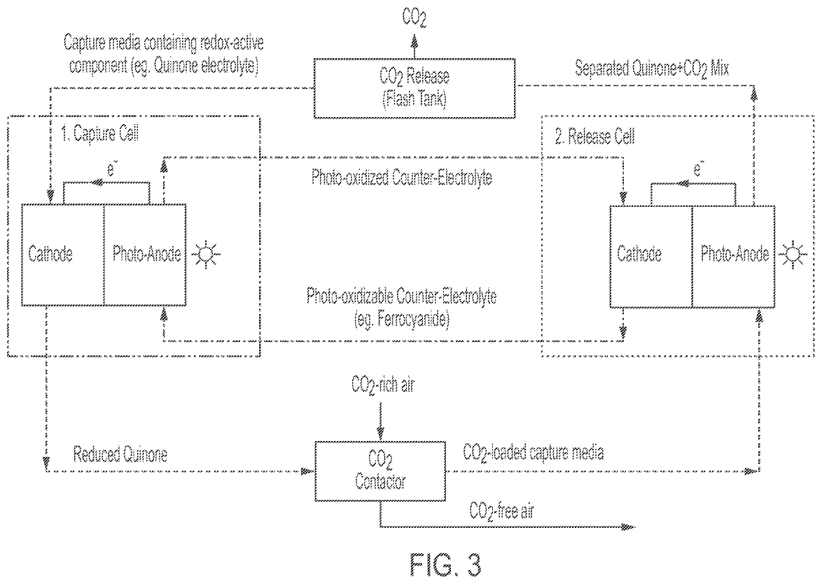

An example of such a method for the capture and release of CO₂ from a fluid gas mixture is depicted in FIG. 3. In this example, a redox-active quinone molecule flows through the cathode of a first dual-chamber photoelectrochemical flow cell (the “capture cell”), while a redox-active anolyte flows through the anode chamber. The electrode at the anode is a photoanode which, upon illumination produces an optoelectronic effect, specifically the production of an electron-hole pair, at the interface of a semiconductor material (the photoelectrode) and a liquid anolyte that contains redox active species, which results in the subsequent oxidation of redox-active species in contact with the photoanode. This oxidation transfers an electron through an external circuit to the cathode, where the redox-active quinone molecule is reduced. The reduced quinone-containing catholyte is then brought into contact with a gas mixture containing CO₂ and removes the CO₂ from the gas mixture by virtue of either dissolving it into an electrolyte by increasing the pH of an electrolyte solution, or by chemically binding to the acid gas molecule. The CO₂-loaded quinone electrolyte is then passed through the anode of a second photoelectrochemical cell (the “release cell”), wherein illumination of the photoanode facilitates the oxidation of the CO2-loaded quinone electrolyte and releases the CO₂ while regenerating the quinone-containing electrolyte for subsequent repeated capture. The regenerated quinone-containing electrolyte is then recycled into the cathode of the first photoelectrochemical cell whereby it is reduced to repeat the capture process described above. The oxidized redox-active anolyte from the first photoelectrochemical cell is used as the counter-electrolyte at the cathode in the release cell where it is reduced and recycled back to the capture cell to be oxidized by the photoanode again.

In some embodiments, the capture is facilitated by an illuminated photoelectrochemical cell, while the release of the acid gas is facilitated by a conventional electrochemical cell, without illumination.

In other embodiments, the capture by facilitated in a conventional electrochemical cell, without illumination, while the release of the gas is facilitated by an illuminated photoelectrochemical cell.

In other embodiments, the capture or release is facilitated through another mechanism while the opposite process is facilitated by an illuminated photoelectrochemical cell.

In other embodiments, the capture media can act as both the catholyte and anolyte, whereby the acid gas-free electrolyte is flowed through the cathode to be reduced and activated for acid gas capture, while the acid gas-rich electrolyte is flowed through the anode to be oxidized and facilitate the release of the acid gas from the capture media.

### Section 1.2 A Photoelectrochemical Apparatus that Facilitates the Activation of the Ability of the System to Capture Acid Gases Upon Illumination With Light

The method described in section 1.1 relies on the illumination of a photoelectrochemical apparatus that facilitates the activation of the ability of the system to capture acid gases upon illumination with light. The photoelectrochemical apparatus comprises a dual chamber photoelectrochemical flow cell in which a catholyte flows through the cathode chamber, and an anolyte flows through the anode chamber. Either or both the cathode and anode may be illuminated with light.

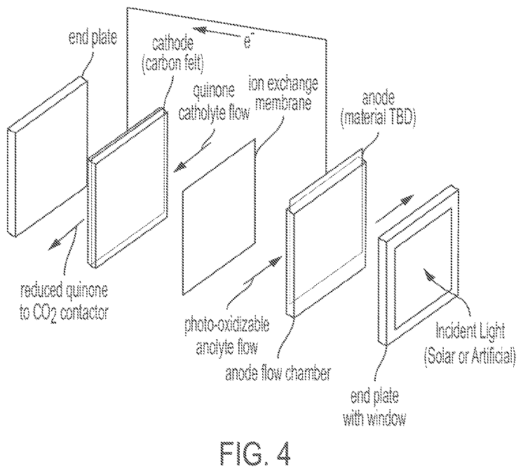

In some embodiments, the photoelectrochemical flow cell includes the following main active components that are depicted in FIG. 4. The main components of the photoelectrochemical flow cell include: (1) the anode flow chamber which contacts the anolyte with an electrode that may be a photoanode, which, upon illumination produces an optoelectronic effect, specifically the production of an electron-hole pair, at the interface of a semiconductor material (the photoanode) and a liquid anolyte that contains redox active species, which results in the subsequent oxidation of redox-active species in contact with the photoanode; (2) an ion exchange membrane that facilitates the diffusion of ions between the anode and cathode chambers of the photoelectrochemical flow cell to maintain charge neutrality; (3) the catholyte flow chamber which contacts the catholyte with an electrode that may be a photocathode, which, upon illumination produces an optoelectronic effect, specifically the production of an electron-hole pair, at the interface of a semiconductor material (the photocathode) and a liquid catholyte that contains redox active species, which results in the subsequent reduction of redox-active species in contact with the photoanode.

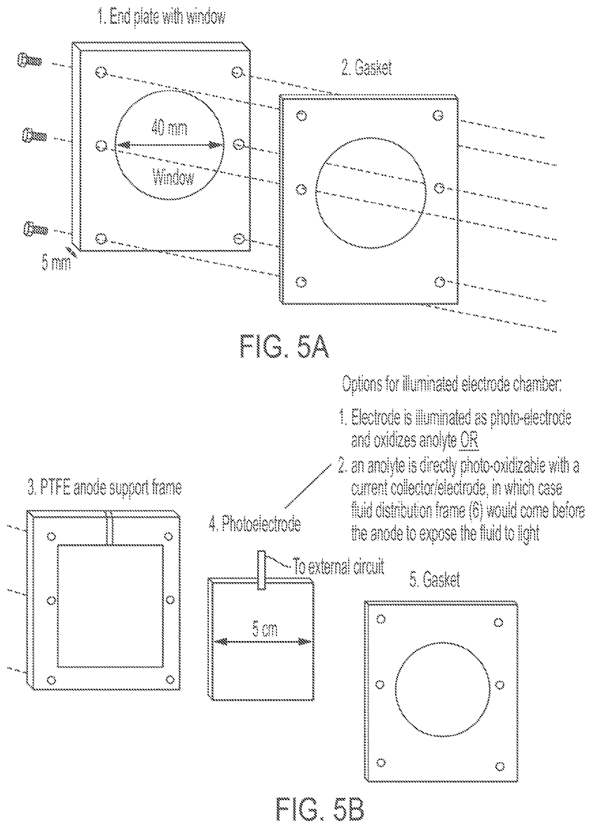

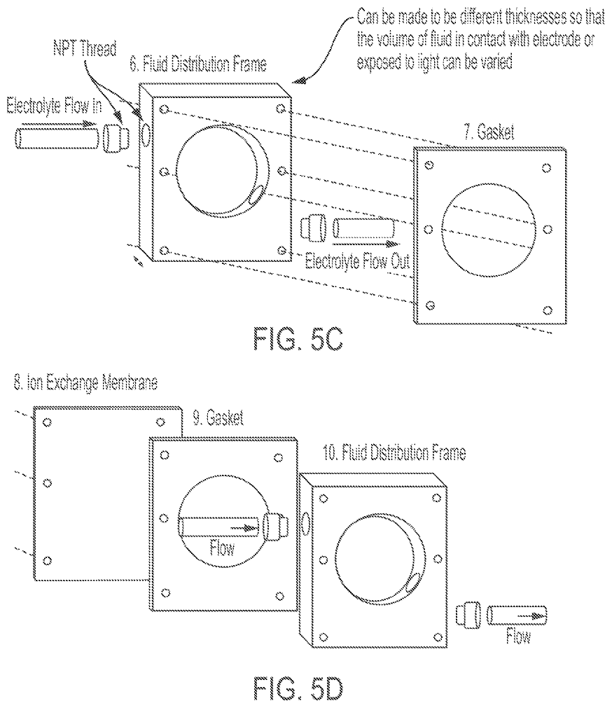

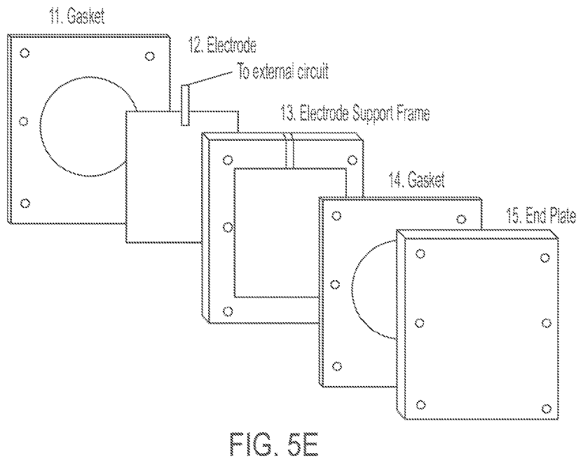

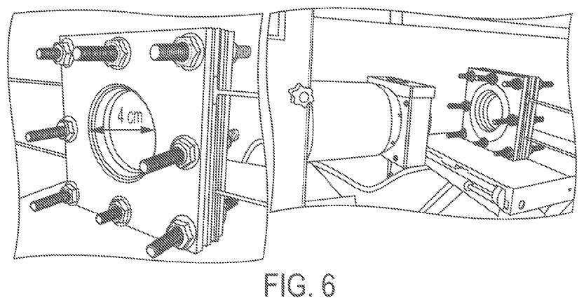

In some embodiments, the photoelectrochemical flow cell has the following component layers: (1) end plate with window; (2) gasket; (3) electrode support frame; (4) (Photo)*-electrode; (5) Gasket; (6) Fluid Distribution frame; (7) Gasket; (8) Ion exchange membrane; (9) Gasket; (10) Fluid Distribution frame; (11) Gasket; (12) Electrode; (13) PTFE electrode support frame; (14) Gasket; (15) End plate. The assembly of these components is depicted in FIGS. 5A-5E. A drawing of such a photoelectrochemical flow cell is shown in FIG. 6.

In some embodiments, either anode or cathode can be photo-activated, or both the anode and cathode can be photo-activated in a so-called “tandem” photoelectrochemical system.

In other embodiments, the electrolyte flowing through either or both the anode flow chambers containing the redox active species may be directly illuminated and photo-oxidized in the absence of a photoanode.

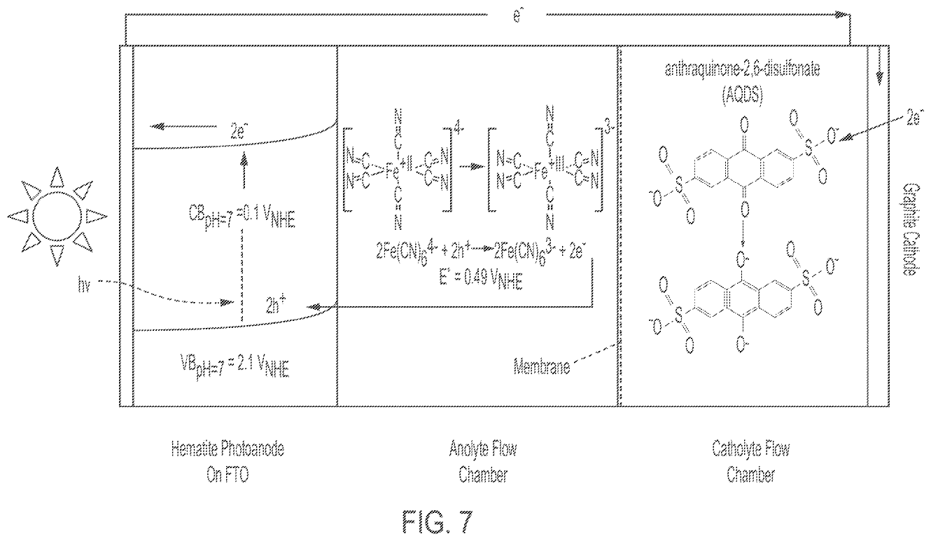

Example component materials for a photoelectrochemical flow cell for the capture of CO₂ are shown in FIG. 7. In this example, a photoanode composed of a hematite thin film supported on a fluorine-doped tin oxide (FTO) substrate is illuminated with light, which facilitates the production of an electron-hole pair. This charge carrier separation produces a driving force for the oxidation of the anolyte which is composed of an aqueous ferrocyanide solution. The oxidation of ferrocyanide produces an electron that is absorbed by the hematite photoelectrode. Continuous illumination and subsequent oxidation of the ferrocyanide species via this mechanism produces an electric current that travels through an external circuit to the cathode, where it is conducted into the catholyte which is composed of an aqueous anthraquinone-2,6-disulfonate (AQDS) solution, which is subsequently reduced. This reduction can facilitate an increase in pH through the hydrogenation of the reduced AQDS or can produce a quinonic dianion which is able to chemically bond to a CO2 molecule to form an adduct.

### Section 1.3 a System for Capturing Acid Gases That Includes the Light-mediated apparatus and auxiliary process components

The method for capturing acid gases using a light-mediated apparatus described in section 1.1 and depicted in FIG. 3 may include several auxiliary components that comprise a system for capturing acid gases. In addition to the photoelectrochemical or electrochemical flow cells that facilitate the oxidation or reduction of the anolyte and catholyte, respectively, the system can include a contactor that brings the fluid gas mixture containing the acid gas into contact with the reduced or activated capture media in order for it to be removed from the fluid gas mixture. In this instance the contactor serves as the contactor described above. In addition, there may exist a release tank in which the captured acid gas is recovered and pumped out of the system from the capture media after it has been photoelectrochemically or electrochemically released from the electrolyte solution in the release cell. This may be a “flash tank”.

U.S. Provisional Patent Application No. 63/373,897, filed Aug. 30, 2022, and entitled “Photoelectrochemical Capture of Acid Gases (Solar-Driven Carbon Dioxide Capture),” is incorporated herein by reference in its entirety for all purposes.

The following examples are intended to illustrate certain embodiments of the present invention, but do not exemplify the full scope of the invention.

### Example b 1

### Preliminary Data Demonstrating the Light-mediated Capture of CO₂ From a Fluid Gas mixture

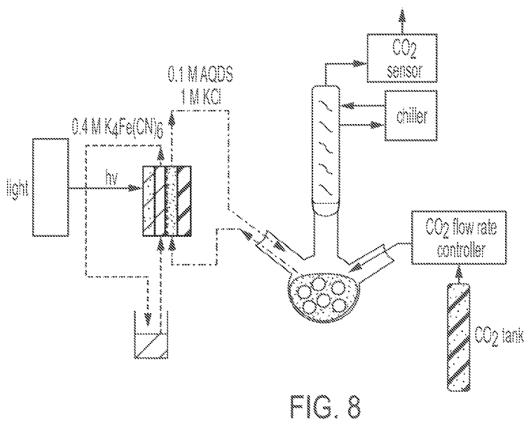

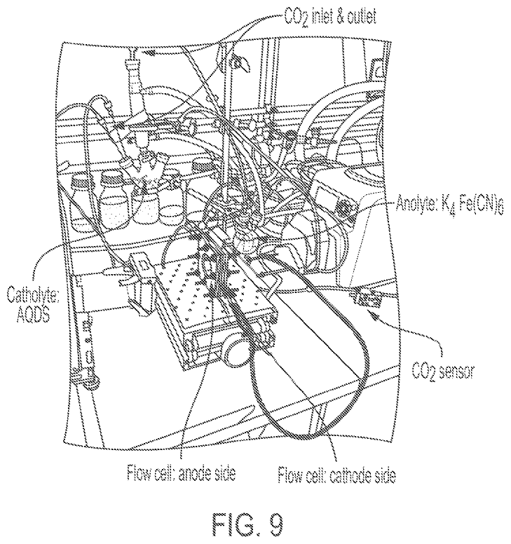

This Example describes preliminary experiments demonstrating the capture of an acid gas using a system of the present disclosure. A schematic of an example system demonstrating the capture cell component of the method described in section 1.1 and the system described in section 1.3 is shown in FIG. 8, and a drawing of the system is shown in FIG. 9. In this example system, a photoelectrochemical cell using the component materials described in section 1.2 and depicted in FIG. 7 is used to facilitate the capture of CO₂ from a mixed gas stream. The example system is comprised of the photoelectrochemical cell through which the ferrocyanide and AQDS solutions flow from reservoirs. The hematite photoanode is illuminated using a solar simulator that delivers 1 kW m⁻² (1 “sun”) of illumination with the characteristic AM1.5 spectra. Upon illumination, the ferrocyanide is oxidized, producing an electric current that travels through the external circuit to the cathode chamber where it reduces the AQDS capture media. The capture media containing the reduced AQDS is then flowed to a contactor, and a gas mixture containing CO2 is bubbled through the capture media and removed from the initial gas mixture. The CO2-depleted gas is then contacted with a sensor that reads the outlet CO₂ concentration.

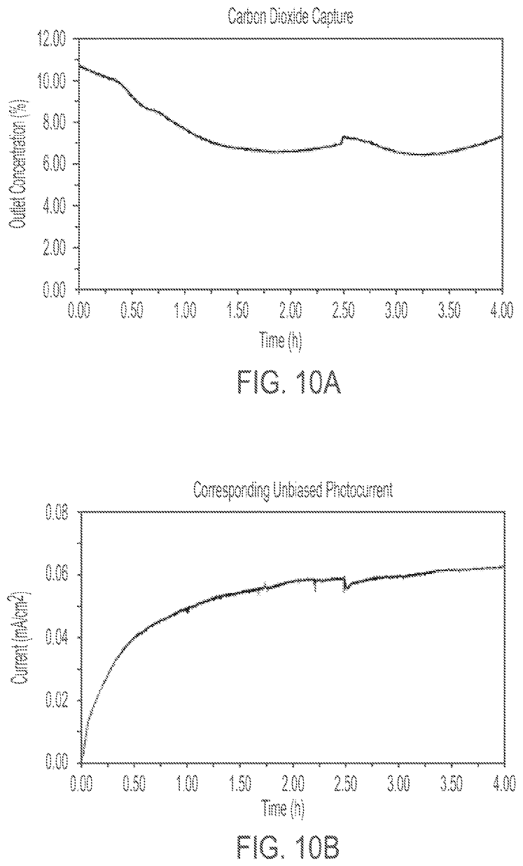

Preliminary data demonstrating the use of this system is shown in FIGS. 10A-10B. In this demonstration, a gas mixture containing CO₂ and nitrogen gas was bubbled through the contactor. The unbiased photoelectrochemical cell, having no externally applied electrical or thermal energy, produced a photocurrent close to 0.06 mA cm⁻² which was able to reduce the concentration of CO₂ in the inlet mixed gas from 10.65% to 6.57%, indicating a depletion of CO₂ in the inlet mixed gas of 38.30% in these preliminary tests.

### Example2

This Example describes additional, later experiments demonstrating the capture of an acid gas using a system of the present disclosure.

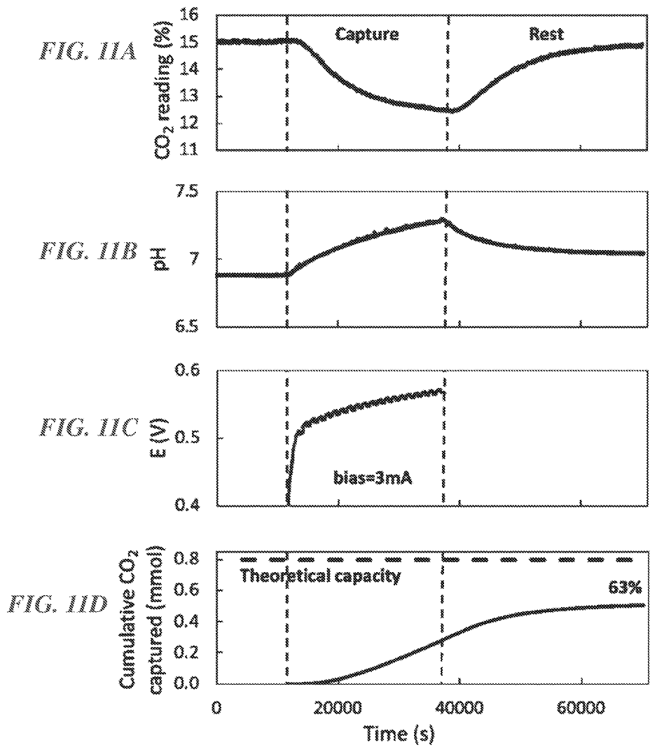

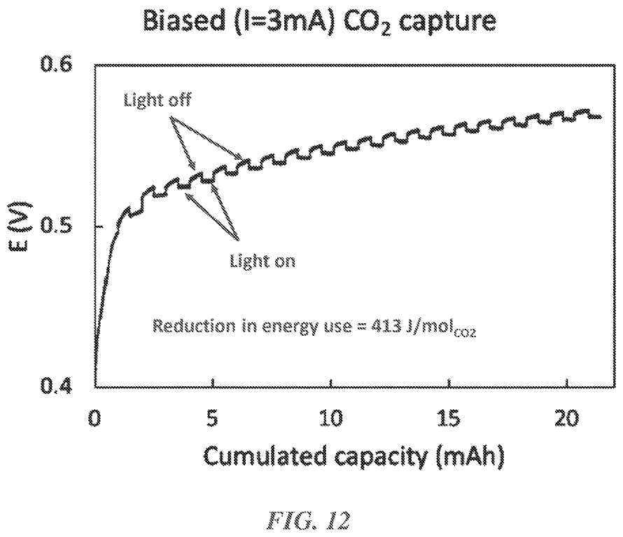

FIGS. 11A-11D show plots of data for various metrics of CO₂ capture performance using the same photoelectrochemical system as in Example 1. FIG. 11A shows a reduction of CO₂ concentration in the gas corresponding with an increase in pH of the catholyte shown in FIG. 11B when the relevant photoelectrochemical and electrochemical reactions begin to take place. FIG. 11A also shows an increase in CO₂ concentration after the system is turned off and the CO₂ capture mechanism ceases to take place. FIG. 11C shows corresponding energy used by the cell over time, as described by the cell voltage. FIG. 12 is a detail of FIG. 11C and shows a reduction in the cell voltage required to capture CO2 when the light is turned on, as well as the return to higher energy usage when the light is turned off. The light was turned on and off periodically for a period of time. The data in FIG. 12 indicate that a reduction of 413 J/mol_{co2} in the energy used by the cell to capture CO₂ was observed when the cell was illuminated with light. FIG. 11D shows that the cell was able to reach 63% of its theoretical capacity for CO₂ capture.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present invention.

As used herein in the specification and in the claims, the phrase “at least a portion” or “at least some” means some or all. “At least a portion” may mean, in accordance with certain embodiments, at least 1 wt %, at least 2 wt %, at least 5 wt %, at least 10 wt %, at least 25 wt %, at least 50 wt %, at least 75 wt %, at least 90 wt %, at least 95 wt %, or at least 99 wt %, and/or, in certain embodiments, up to 100 wt %.

The indefinite articles “a” and “an,” as used herein in the specification and in the claims, unless clearly indicated to the contrary, should be understood to mean “at least one.”The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

Unless clearly indicated to the contrary, concentrations and percentages described herein are on a mass basis.

As used herein, “wt%” is an abbreviation of weight percentage. As used herein, “at%” is an abbreviation of atomic percentage.

Some embodiments may be embodied as a method, of which various examples have been described. The acts performed as part of the methods may be ordered in any suitable way. Accordingly, embodiments may be constructed in which acts are performed in an order different than illustrated, which may include different (e.g., more or less) acts than those that are described, and/or that may involve performing some acts simultaneously, even though the acts are shown as being performed sequentially in the embodiments specifically described above.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

In the claims, as well as in the specification above, all transitional phrases such as “comprising,” “including,” “carrying,” “having,” “containing,” “involving,” “holding,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A system for gas separation, comprising:
an electrochemical cell comprising:
a first chamber comprising:
a first electrode,
an inlet configured to receive a fluid mixture comprising a deactivated electroactive sorbent, and
an outlet configured to output a fluid mixture comprising an activated electroactive sorbent generated in at least in part via an electron transfer reaction involving the first electrode; and
a second chamber comprising a second electrode in electrical communication with the first electrode, wherein the first electrode and/or the second electrode is a photoelectrode; and
a contactor configured to expose activated electroactive sorbent to a fluid mixture comprising an acid gas, wherein the activated electroactive sorbent has:
(a) a higher binding constant for bonding to the acid gas or a portion thereof than does the deactivated electroactive sorbent; and/or
(b) a higher pKₐ in water at 298 κ than does the deactivated electroactive sorbent;
wherein the contactor comprises:
a sorbent inlet fluidically connected to the outlet of the first chamber, and
an acid gas inlet configured to receive the fluid mixture comprising the acid gas.

2. The system of claim 1, wherein the activated electroactive sorbent has a higher binding constant for bonding to the acid gas or a portion thereof than does the deactivated electroactive sorbent.

3. The system of claim 1, wherein the activated electroactive sorbent has a higher pKₐ in water at 298 κ than does the deactivated electroactive sorbent.

4. The system of claim 1, wherein the first electrode is a cathode and the second electrode is an anode.

5. The system of claim 1, wherein the second electrode is a photoelectrode.

6. The system of claim 1, wherein the inlet of the first chamber is fluidically connected to a source of the fluid mixture comprising the deactivated electroactive sorbent.

7. The system of claim 6, wherein the fluid mixture comprising the deactivated electroactive sorbent comprises a liquid and the deactivated electroactive sorbent at least partially dissolved in the liquid.

8. The system of claim 1, wherein the deactivated electroactive sorbent comprises an optionally-substituted quinone.

9. The system of claim 1, wherein the acid gas inlet of the contactor is fluidically connected to a source of the fluid mixture comprising the acid gas.

10. The system of claim 9, wherein the acid gas comprises CO₂, SOₓ, NOₓ, H₂S, HF, HCl, HBr, HI, a borane, and/or Cl₂O.

11. The system of claim 1, wherein the second chamber of the electrochemical cell comprises:
an inlet configured to receive a fluid mixture comprising a counter-electrolyte in a first oxidation state, and
an outlet configured to output a fluid mixture comprising the counter-electrolyte in a second oxidation state.

12. The system of claim 1, wherein the contactor comprises an outlet configured to output captured acid gas.

13. The system of claim 12, wherein the captured acid gas or a portion thereof is bonded to the activated electroactive sorbent.

14. The system of claim 1, wherein the contactor comprises an outlet configured to output a fluid mixture having no acid gas or a lower amount of the acid gas than the fluid mixture comprising the acid gas.

15. The system of claim 1, wherein the electrochemical cell is a first electrochemical cell, and the system further comprises a second electrochemical cell comprising:
a first chamber comprising a first electrode; and
a second chamber comprising:
a second electrode in electrical communication with the first electrode,
an inlet fluidically connected to the outlet of the contactor configured to output captured acid gas, and
an outlet configured to output released acid gas.

16. The system of claim 15, wherein the first electrode and/or the second electrode of the second electrochemical cell is a photoelectrode.

17. The system of claim 15, wherein the first chamber of the second electrochemical cell comprises:
an inlet fluidically connected to the outlet of the second chamber of the first electrochemical cell, and
an outlet fluidically connected to the inlet of the second chamber of the first electrochemical cell.

18. A method for gas separation, comprising:
exposing a first electrode and/or a second electrode of an electrochemical cell to electromagnetic radiation such that an electron transfer reaction occurs resulting in a deactivated electroactive sorbent being converted to an activated electroactive sorbent within the electrochemical cell;
removing at least some of the activated electroactive sorbent from the electrochemical cell; and
exposing at least some of the removed activated electroactive sorbent to a fluid mixture comprising an acid gas such that the at least some of the removed activated electroactive sorbent induces capture of the acid gas from the fluid mixture.

19. The method of claim 18, wherein the at least some of the removed activated electroactive sorbent induces capture of the acid gas from the fluid mixture at least in part by bonding to the acid gas or a portion thereof.

20-31. (canceled)

32. A method for gas separation, comprising:
exposing a deactivated electroactive sorbent and/or a component in redox communication with the deactivated electroactive sorbent to electromagnetic radiation such that an electron transfer reaction occurs resulting in the deactivated electroactive sorbent being converted to an activated electroactive sorbent within an electrochemical cell; and
exposing at least some of the activated electroactive sorbent to an acid gas such that the at least some of the activated electroactive sorbent covalently bonds to the acid gas or a portion thereof.

33-38. (canceled)
